(19) United States
(12) Patent Application Publication
(10) Pub. No.: US 2025/0339859 A1
(43) Pub. Date: Nov. 6, 2025

(54) COLLECTED SAMPLE PRE-TREATMENT DEVICE AND COLLECTED SAMPLE PRE-TREATMENT METHOD

(71) Applicant: MICRO DIGITAL CO., LTD, Seongnam-si, Gyeonggi-do (KR)

(72) Inventors: Kyung Nam KIM, Gwangju-si, Gyeonggi-do (KR); Se Hak LIM, Gunpo-si, Gyeonggi-do (KR); Jong In RYU, Yongin-si, Gyeonggi-do (KR); Tae Hyun KIM, Seongnam-si, Gyeonggi-do (KR)

(21) Appl. No.: 18/872,426

(22) PCT Filed: May 17, 2023
(86) PCT No.: PCT/KR2023/006704

§ 371 Date: Dec. 6, 2024

(30) Foreign Application Priority Data
Sep. 28, 2022 (KR) 10-2022-0123433
Jan. 9, 2023 (KR) 10-2023-0002808

(51) Int. Cl. B01L 3/00

(52) U.S. Cl. CPC B01L 3/52; B01L 2200/025; B01L 2200/04; B01L 2200/16; B01L 2300/043; B01L 2300/0609; B01L 2300/123

(57) ABSTRACT

Provided is a collected sample pretreatment apparatus capable of rapidly and accurately analyzing a deoxyribonucleic acid (DNA) or ribonucleic acid (RNA) sample collected by a swab or another collector, through a series of automated processes, the collected sample pretreatment apparatus including a housing, a cartridge mounting device to hold a cartridge, a spin drive device coupled with a spin tip provided in the cartridge or the cartridge mounting device to rotate the spin tip, a pump drive device coupled with a dispensing tip provided in the cartridge or the cartridge mounting device to dispense a buffer solution by using the dispensing tip, and a tip removal device to remove the spin tip from the spin drive device or the dispensing tip from the pump drive device by using relative motion of the spin drive device and the pump drive device.

### TECHNICAL FIELD

The present invention relates to a sample pretreatment apparatus, and more particularly, to a collected sample pretreatment apparatus and collected sample pretreatment method capable of rapidly and accurately analyzing a deoxyribonucleic acid (DNA) or ribonucleic acid (RNA) sample collected by a swab or another collector, through a series of automated processes.

### BACKGROUND ART

Molecular diagnostics is a diagnostic method capable of enabling early diagnosis and efficient treatment of a disease by directly analyzing genes (e.g., deoxyribonucleic acid (DNA) or ribonucleic acid (RNA)) of a sample which is a target substance to identify disease infection, nucleotide sequence variation, or mutation.

Currently, molecular diagnostics is being used in various medical fields such as disease infection identification, genetic testing, and pharmacogenetic testing.

Various detection methods have been developed for molecular diagnostics, and real-time polymerase chain reaction is being widely used today in terms of its speed, convenience, and detection sensitivity. Real-time polymerase chain reaction generally uses a probe that forms a specific complementary bond with a target gene, and a fluorescence molecule is bound to the probe. In real-time polymerase chain reaction, qualitative/quantitative analysis of the target gene is conducted by analyzing the wavelength of the fluorescence molecule by using an analytical instrument.

Meanwhile, molecular diagnostics pretreats a target substance on a swab or a collector through real-time polymerase chain reaction and then analyzes the pretreated substance, i.e., a buffer solution. According to the existing technology, due to individual configurations for performing various processes required for molecular diagnostics, molecular diagnostic equipment has a large size and a complex structure, a cost and time required for pretreatment are wasted a lot, and a series of these processes are not easily automated.

### DETAILED DESCRIPTION OF THE INVENTION

### Technical Problem

The present invention provides a collected sample pretreatment apparatus and collected sample pretreatment method by which the efficiency of extracting a collected sample may be increased by automating and integrating a series of processes for extracting the collected sample from a swab or a collector into a buffer solution to apply molecular diagnostics, in a cartridge manner, a time and cost required to extract the sample may be significantly reduced, the collected sample may be pretreated very precisely, uniformly, and reliably regardless of the user skill level or the test environment, the contamination or leakage of the sample during the processes may be fundamentally prevented, on-site test results may also be rapidly obtained within minutes to hours by using rapid diagnostic kits, and pretreatment may be performed very hygienically by discarding or incinerating all used components at a time after the processes are completed. However, the above description is an example, and the scope of the present invention is not limited thereto.

### Technical Solution

According to an aspect of the present invention, there is provided a collected sample pretreatment apparatus including a housing, a cartridge mounting device mounted inside the housing to hold a cartridge, a spin drive device mounted in the housing and coupled with a spin tip provided in the cartridge or the cartridge mounting device to rotate the spin tip, a pump drive device mounted in the housing and coupled with a dispensing tip provided in the cartridge or the cartridge mounting device to dispense a buffer solution by using the dispensing tip, and a tip removal device mounted in the housing and to remove the spin tip from the spin drive device or the dispensing tip from the pump drive device by using relative motion of the spin drive device and the pump drive device.

The cartridge mounting device may include a cartridge holder for holding the cartridge, a cartridge guide rail for guiding the cartridge holder, and a holder moving device for moving the cartridge holder along the cartridge guide rail to move the cartridge mounted in the cartridge holder to a position corresponding to the spin drive device or a position corresponding to the pump drive device.

The holder moving device may include a driven pulley mounted to rotate freely at a side of the housing or a frame, a drive pulley mounted to rotate freely at another side of the housing or the frame, a holder drive motor for rotating the drive pulley, and a belt having a side fixed to the cartridge holder, and wound between the driven pulley and the drive pulley to move along a track.

The spin drive device may include a first platform mounted to be raised or lowered along a first rail mounted at a front side of a main base, a spin head rotatably mounted on the first platform and coupled with a spin cover or filter tip coupled with an extraction tip including a collection of the cartridge, a spin motor mounted on the first platform to spin the spin head, and a first platform drive device for raising or lowering the first platform.

The first platform drive device may include a first extension extending from the first platform to penetrate through a first through hole vertically formed in the main base, and having a first nut member mounted thereon, a first screw rod mounted to rotate freely behind the main base, and screw-penetrating through the first nut member, a first driven pulley mounted on the first screw rod, a first drive pulley rotatably mounted on an extension base connected to the main base, a first platform drive motor mounted on the extension base to rotate the first drive pulley, and a first belt wound between the first drive pulley and the first driven pulley to transmit rotational force of the first drive pulley to the first driven pulley.

The pump drive device may include a second platform mounted to be raised or lowered along a second rail mounted at another front side of the main base, a pump head mounted on the second platform to enable dispensing and coupled with the dispensing tip or the filter tip, a dispensing pump mounted on the second platform and connected to the pump head to suck or dispense the buffer solution, and a second platform drive device for raising or lowering the second platform.

The second platform drive device may include a second extension extending from the second platform to penetrate through a second through hole vertically formed in the main base, and having a second nut member mounted thereon, a second screw rod mounted to rotate freely behind the main base, and screw-penetrating through the second nut member, a second driven pulley mounted on the second screw rod, a second drive pulley rotatably mounted on an extension base connected to the main base, a second platform drive motor mounted on the extension base to rotate the second drive pulley, and a second belt wound between the second drive pulley and the second driven pulley to transmit rotational force of the second drive pulley to the second driven pulley.

The collected sample pretreatment apparatus may further include a position detection sensor mounted on a horizontal frame mounted on the main base, to detect a raised or lowered position of a detection target object provided on each of the first and second extensions, by using a light emitter and a light receiver, and a controller for receiving a position signal from the position detection sensor to apply a control signal to the first or second platform drive device.

The tip removal device may include a tip removal block mounted to be raised or lowered along the first and second rails to press the spin tip or the dispensing tip, a first through hole provided in a portion of the tip removal block and having an inner diameter which is greater than an outer diameter of the spin head to allow the spin head to pass downward and which is less than an outer diameter of the spin tip to remove the spin tip coupled with the spin head when the spin head passes upward, and a second through hole provided in another portion of the tip removal block and having an inner diameter which is greater than an outer diameter of the pump head to allow the pump head to pass downward and which is less than an outer diameter of the dispensing tip to remove the dispensing tip coupled with the pump head when the pump head passes upward.

The tip removal device may further include an elastic support block mounted to be raised or lowered along the second rail, having the second platform mounted at a side to prevent falling of the tip removal block and adjust a height of the tip removal block in conjunction with the second platform, and elastically supporting the tip removal block by using a spring of a spring bar mounted on the tip removal block.

In the cartridge mounting device, a stopper may be provided on the cartridge holder so as to be elastically coupled with a protrusion provided on the cartridge when the cartridge is inserted.

The housing may have a hinged door mounted at front to selectively open or close a cartridge inlet provided at front, a handle provided on top for carrying, an ultraviolet (UV) germicidal lamp mounted inside for disinfection after sample extraction, and command input buttons and display device mounted on a front surface.

### Advantageous Effects

According to the afore-described embodiments of the present invention, the efficiency of extracting a collected sample may be increased by automating and integrating a series of processes for extracting the collected sample from a collection member such as a swab into a buffer solution to apply molecular diagnostics, in a cartridge manner, a time and cost required to extract the collected sample may be significantly reduced, the collected sample may be pretreated very precisely, uniformly, and reliably regardless of the user skill level or the test environment, the contamination or leakage of the sample during the processes may be fundamentally prevented, on- site test results may also be rapidly obtained within minutes to hours by using rapid diagnostic kits, a test may be facilitated by automating all pretreatment processes including a spin mode, an extraction mode, a dispensing mode, an agitation mode, and a tip removal mode, and the reliability and uniformity of the test may be significantly increased. However, the scope of the present invention is not limited to the above effects.

### DESCRIPTION OF THE DRAWINGS

FIG. 1 is an external perspective view of a collected sample extraction cartridge according to embodiments of the present invention.

FIG. 2 is a cross-sectional view of the collected sample extraction cartridge of FIG. 1.

FIGS. 3 to 23 are cross-sectional views showing a collected sample extraction process of the collected sample extraction cartridge of FIG. 1 step by step.

FIG. 24 is a flowchart of a collected sample extraction method according to embodiments of the present invention.

FIG. 25 is a detailed flowchart of step (a) of the collected sample extraction method of FIG. 24

FIG. 26 is a detailed flowchart of step (c) of the collected sample extraction method of FIG. 24.

FIG. 27 is a detailed flowchart of step (f) of the collected sample extraction method of FIG. 24.

FIG. 28 is an external perspective view of a collected sample pretreatment apparatus according to embodiments of the present invention.

FIG. 29 is an external perspective view showing a door open state of the collected sample pretreatment apparatus of FIG. 28.

FIG. 30 is an internal perspective view of the collected sample pretreatment apparatus of FIG. 28.

FIG. 31 is a perspective view of a cartridge mounting device of the collected sample pretreatment apparatus of FIG. 28.

FIG. 32 is a perspective view of a spin drive device of the collected sample pretreatment apparatus of FIG. 28.

FIG. 33 is a perspective view of a pump drive device of the collected sample pretreatment apparatus of FIG. 28.

FIG. 34 is a rear perspective view of a main base of the collected sample pretreatment apparatus of FIG. 28.

FIGS. 35 to 37 are rear perspective views of the spin drive device and the pump drive device of the collected sample pretreatment apparatus of FIG. 28.

FIG. 38 is a conceptual view of a position detection sensor of the collected sample pretreatment apparatus of FIG. 37.

FIGS. 39 to 41 are perspective views of a tip removal device of the collected sample pretreatment apparatus of FIG. 28.

FIGS. 42 to 44 are perspective views showing a dispensing tip removal process of the collected sample pretreatment apparatus of FIG. 28 step by step.

FIGS. 45 to 47 are perspective views showing a spin cover removal process of the collected sample pretreatment apparatus of FIG. 28 step by step.

FIGS. 48 to 50 are side views showing a cartridge mounting process of the collected sample pretreatment apparatus of FIG. 28 step by step.

### MODE OF THE INVENTION

Hereinafter, the present invention will be described in detail by explaining embodiments of the invention with reference to the attached drawings.

The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the thicknesses or sizes of layers are exaggerated for clarity and convenience of explanation.

A collected sample extraction cartridge usable for a collected sample pretreatment apparatus will now be described in detail.

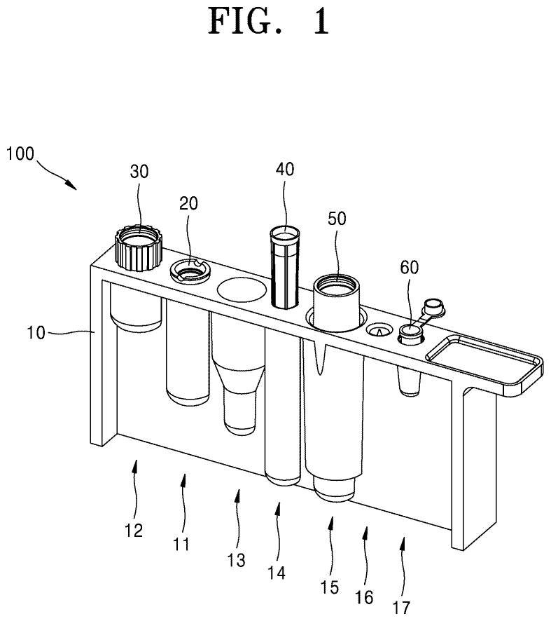

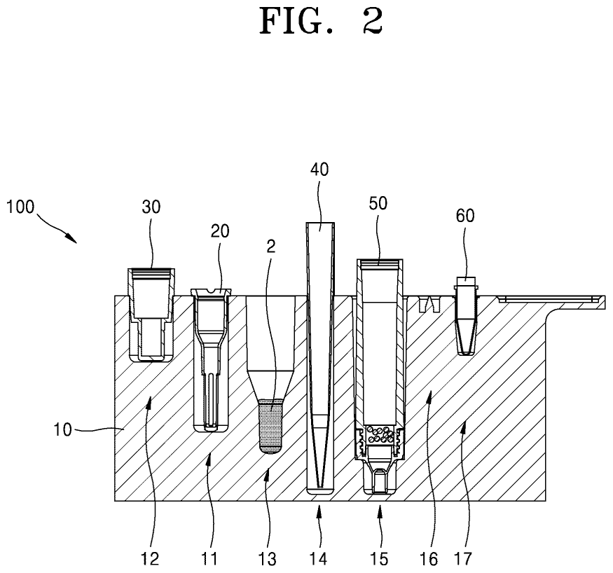

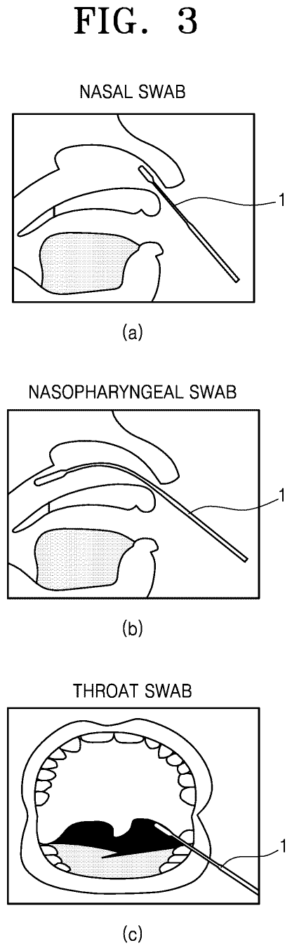

FIG. 1 is an external perspective view of a collected sample extraction cartridge 100 according to embodiments of the present invention, and FIG. 2 is a cross-sectional view of the collected sample extraction cartridge 100 of FIG. 1. FIGS. 3 to 23 are cross-sectional views showing a collected sample extraction process of the collected sample extraction cartridge 100 of FIG. 1 step by step.

Initially, as shown in FIGS. 1 and 2, the collected sample extraction cartridge 100 according to embodiments of the present invention may mainly include a cartridge body 10, and an extraction tip accommodator 11, a spin cover accommodator 12, a buffer chamber 13, a dispensing tip accommodator 14, a filter tip accommodator 15, a sharp part 16, and a collection tube accommodator 17 provided in the cartridge body 10.

For example, as shown in FIGS. 1 and 2, the cartridge body 10 may be detachably mounted in test equipment (not shown) provided at a laboratory or on site, and may be an integral structure made of synthetic resin or metal with sufficient strength and durability to support the above-described extraction tip accommodator 11, spin cover accommodator 12, buffer chamber 13, dispensing tip accommodator 14, filter tip accommodator 15, sharp part 16, and collection tube accommodator 17.

However, the shape, type, material, design, or the like of the cartridge body 10 is not limited thereto and may be arbitrarily modified or changed depending on equipment measurements, test environment, required specifications, or the like.

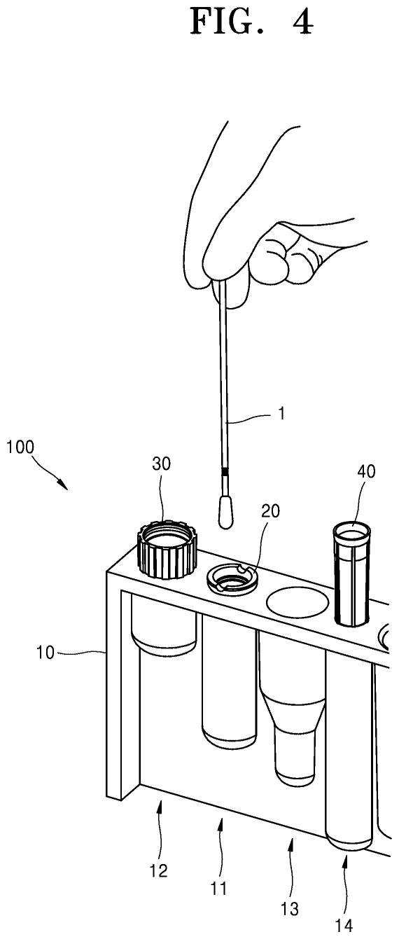

Specifically, for example, as shown in FIGS. 1 and 2, the extraction tip accommodator 11 is provided in the cartridge body 10 and may be a part where an extraction tip 20 is accommodated such that a collection member 1 of FIG. 4 which has collected a sample may be accommodated.

The collection member 1 may include various collectors capable of collecting a sample, e.g., a swab. Although the swab is described as an example of the collection member 1 below, the scope of the present invention is not limited thereto.

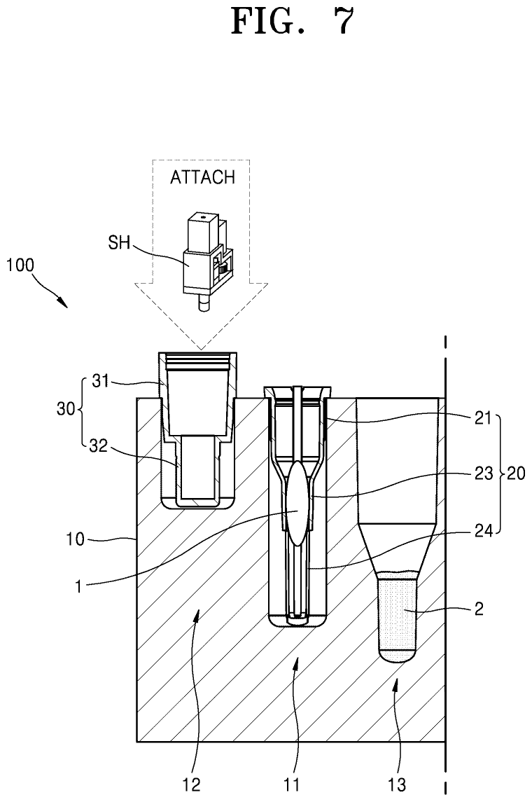

Specifically, for example, as shown in FIGS. 1 and 2, the spin cover accommodator 12 is provided in the cartridge body 10, and may be a part where a spin cover 30 is accommodated such that a spin head SH of FIG. 7 of a robotic device may be attached to the spin cover 30.

Specifically, for example, as shown in FIGS. 1 and 2, the buffer chamber 13 is provided in the cartridge body 10, and may be a part where a buffer solution 2 is accommodated such that the collection member 1 may be immersed in the buffer solution 2 by coupling the spin head SH of the robotic device having the spin cover 30 with the extraction tip 20 and then the sample may be extracted and released from the collection member 1 and accommodated in the buffer solution 2 by rotating the spin head SH.

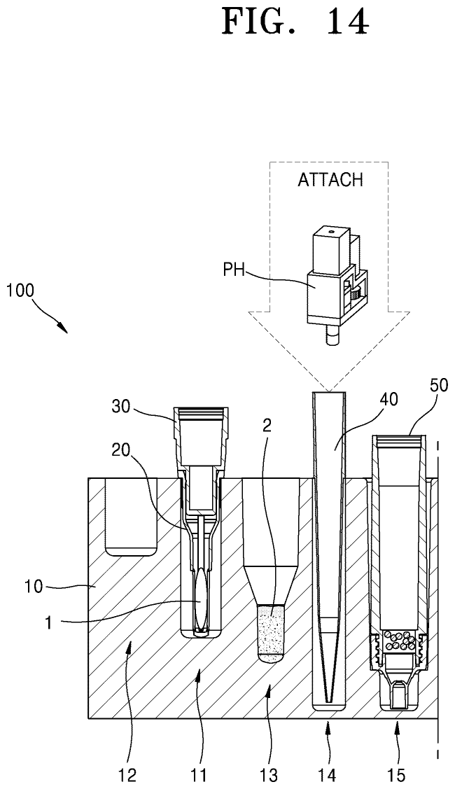

Specifically, for example, as shown in FIGS. 1 and 2, the dispensing tip accommodator 14 is provided in the cartridge body 10, and may be a part where a dispensing tip 40 is accommodated such that the buffer solution 2 including the sample may be sucked by attaching a pump head PH of FIG. 14 of the robotic device to the dispensing tip 40.

Specifically, for example, as shown in FIGS. 1 and 2, the filter tip accommodator 15 is provided in the cartridge body 10, and may be a part where a filter tip 50 is accommodated such that the buffer solution 2 may be agitated by coupling the spin head SH with the filter tip 50 to rotate the filter tip 50, for example, repeatedly clockwise and counterclockwise, when the dispensing tip 40 having sucked the buffer solution 2 including the sample dispenses the buffer solution 2 to the filter tip 50.

Specifically, for example, as shown in FIGS. 1 and 2, the sharp part 16 is provided in the cartridge body 10, and may be a part provided in a pointed shape to break or remove a temporary sealing member 54.

Specifically, for example, as shown in FIGS. 1 and 2, the collection tube accommodator 17 is provided in the cartridge body 10, and may be a part where a final solution collection tube 60 is accommodated such that the buffer solution 2 including the sample may be injected into the final solution collection tube 60 by coupling the pump head PH with the filter tip 50. for example, after the temporary sealing member 54 is broken or removed, the buffer solution 2 including the sample may be injected into the final solution collection tube 60.

Herein, as shown in FIGS. 1 and 2, the extraction tip accommodator 11, the spin cover accommodator 12, the buffer chamber 13, the dispensing tip accommodator 14, the filter tip accommodator 15, the sharp part 16, and the collection tube accommodator 17 may be arranged in a line in the afore-mentioned order from a front end to a rear end on an upper surface of the cartridge body 10 depending on the order of pretreatment processes for extracting the collected sample. However, the above-described arrangement is an example, and the scope of the present invention is not limited thereto.

Therefore, as shown in FIGS. 1 and 2, the distance of motion of the spin head SH and the pump head PH of the robotic device mounted in the above-described test equipment may be minimized. That is, a series of collected sample extraction processes for extracting the sample collected by the collection member 1 and dispensing the buffer solution 2 including the sample into the final solution collection tube 60 while the spin head SH and the pump head PH are intermittently moving from a front end to a rear end of the cartridge body 10 may be sequentially and sufficiently performed within a single collected sample extraction cartridge 100 according to embodiments of the present invention.

Thus, the efficiency of extracting the collected sample may be increased by automating and integrating a series of processes for extracting the sample collected by the collection member 1 into the buffer solution 2 to apply molecular diagnostics, in a cartridge manner, a time and cost required to extract the sample may be significantly reduced, the sample may be pretreated very precisely, uniformly, and reliably regardless of the user skill level or the test environment, the contamination or leakage of the sample during the processes may be fundamentally prevented, and on-site test results may also be rapidly obtained within minutes to hours by using rapid diagnostic kits.

FIGS. 3 to 23 are cross-sectional views showing a collected sample extraction process of the collected sample extraction cartridge 100 of FIG. 1 step by step.

The extraction process of the collected sample extraction cartridge 100 according to embodiments of the present invention will now be described in detail with reference to FIGS. 3 to 23. Initially, as shown in FIG. 3, a sample may be collected from a human body by using a swab, e.g., a nasal swab, a nasopharyngeal swab, or a throat swab, as the collection member 1.

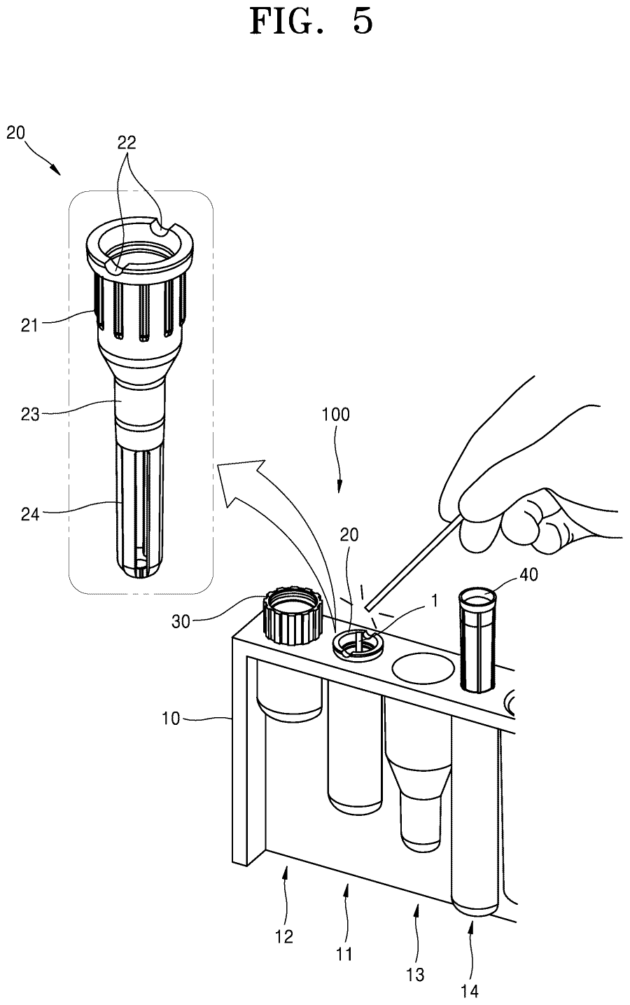

Then, as shown in FIGS. 4 and 5, a portion of the collection member 1 having collected the sample may be inserted into a collection member accommodation region of an extraction tip body 21 of the extraction tip 20 accommodated in the extraction tip accommodator 11 of the cartridge body 10.

Then, as shown in FIG. 5, the collection member 1 may be temporarily fitted to a narrow midsection 23 by breaking and cutting off a portion of the collection member 1.

Herein, for example, as shown in FIG. 5, the extraction tip 20 may include the extraction tip body 21 having the collection member accommodation region to accommodate a portion of the collection member 1, cutting grooves 22 provided at a mouth of the extraction tip body 21 to break and cut off a portion of the collection member 1, the narrow midsection 23 provided under the extraction tip body 21 to allow the collection member 1 to be temporarily fitted, and an extraction slot 24 provided under the narrow midsection 23 to extract the buffer solution 2 including the sample from the collection member 1 due to centrifugal force when rotated using the spin head SH after the collection member 1 is fully inserted.

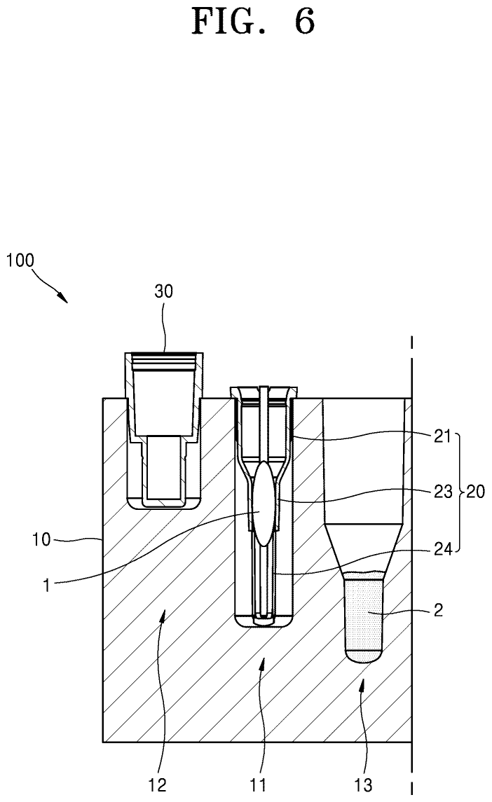

Therefore, as shown in FIG. 6, the collection member 1 may be temporarily fitted to the narrow midsection 23 while a portion thereof is cut off using the cutting grooves 22.

Then, as shown in FIG. 7, the spin head SH of the robotic device may be attached to the spin cover 30 accommodated in the spin cover accommodator 12.

Herein, for example, the spin cover 30 may include a spin cover body 31 having a head coupler to be coupled with the spin head SH, and a pusher 32 inserted through the mouth of the extraction tip body 21 when coupled with the extraction tip 20, to press and fully insert the collection member 1 temporarily fixed to the narrow midsection 23, into the extraction slot 24.

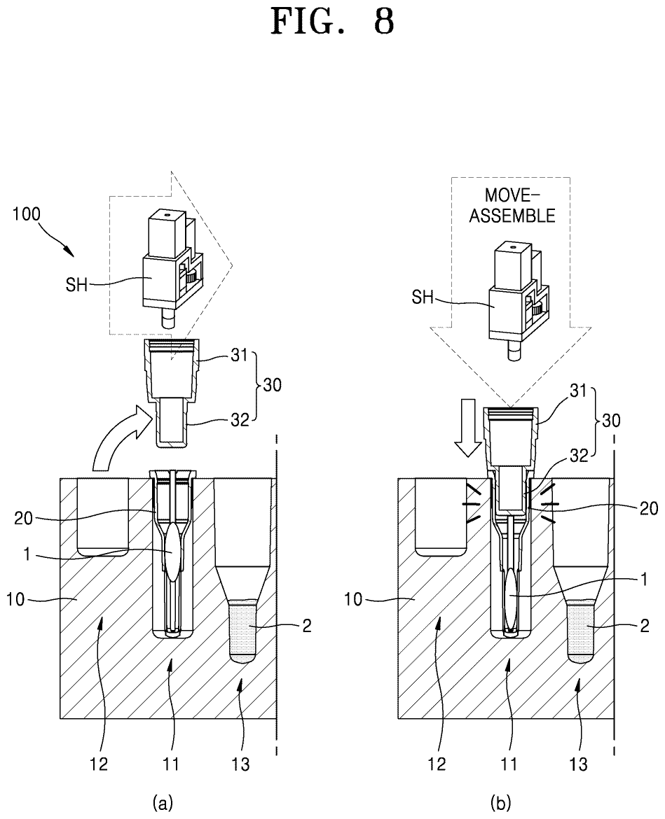

Thereafter, the spin head SH may be aligned above the extraction tip 20 as shown in (a) of FIG. 8, and then the collection member 1 may be pressed and fully inserted into the extraction slot 24 by using the pusher 32 of the spin head SH as shown in (b) of FIG. 8.

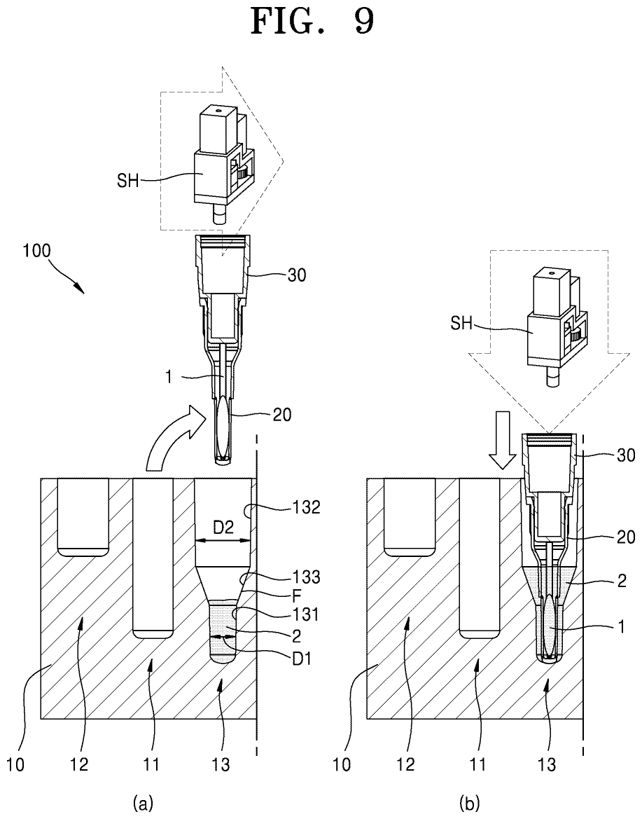

Subsequently, as shown in (a) of FIG. 9, the spin head SH is aligned above the extraction tip 20 and then moves to above the buffer chamber 13 accommodating the buffer solution 2. After that, as shown in (b) of FIG. 9, the spin head SH is lowered to insert the extraction tip 20 into the buffer chamber 13, and thus the collection member 1 may be sufficiently immersed below the level of the buffer solution 2 of the buffer chamber 13.

In this case, as shown in (a) of FIG. 9, the buffer chamber 13 may include a buffer solution accommodator 131 accommodating the buffer solution 2 and having a first diameter D1 to sufficiently immerse the collection member 1 below the level of the buffer solution 2, an extraction part 132 having a second diameter D2 greater than the first diameter D1 to sufficiently raise the collection member 1 above the level of the buffer solution 2 and extract the buffer solution 2 by rotating the collection member 1, and a guide slope 133 including a sloped surface F having a diameter gradually changing from the first diameter D1 to the second diameter D2, to guide the extracted buffer solution 2 toward the buffer solution accommodator 131.

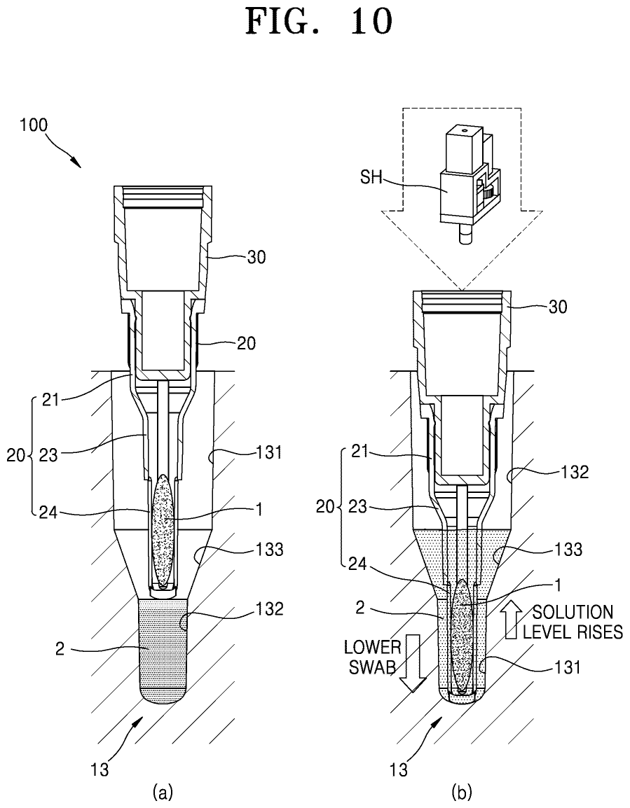

Then, for example, a series of processes for raising the spin head SH as shown in (a) of FIG. 10 and lowering the spin head SH to sufficiently immerse the collection member 1 below the level of the buffer solution 2 of the buffer chamber 13 as shown in (b) of FIG. 10 may be performed once or repeated multiple times.

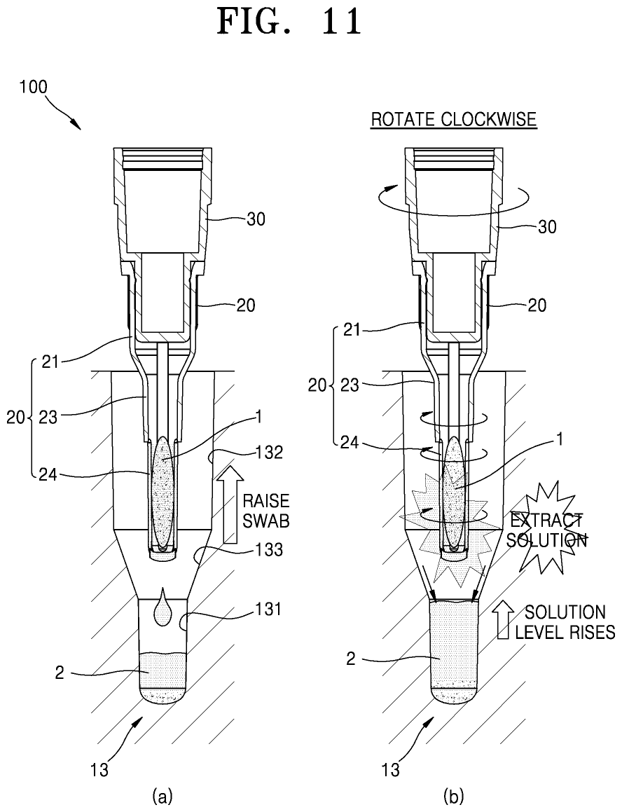

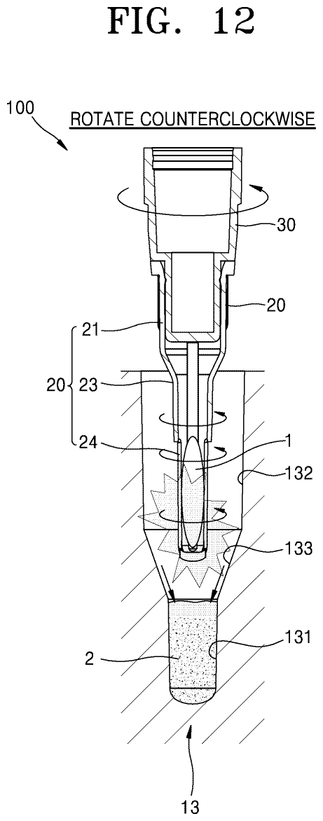

In this case, for example, the collection member 1 may be sufficiently raised above the level of the buffer solution 2 of the buffer chamber 13 as shown in (a) of FIG. 11, and the buffer solution 2 may be sufficiently extracted by repeatedly rotating the spin head SH clockwise and counterclockwise as shown in (b) of FIG. 11 and FIG. 12. As such, the sample collected by the collection member 1 may be accommodated in the buffer solution 2.

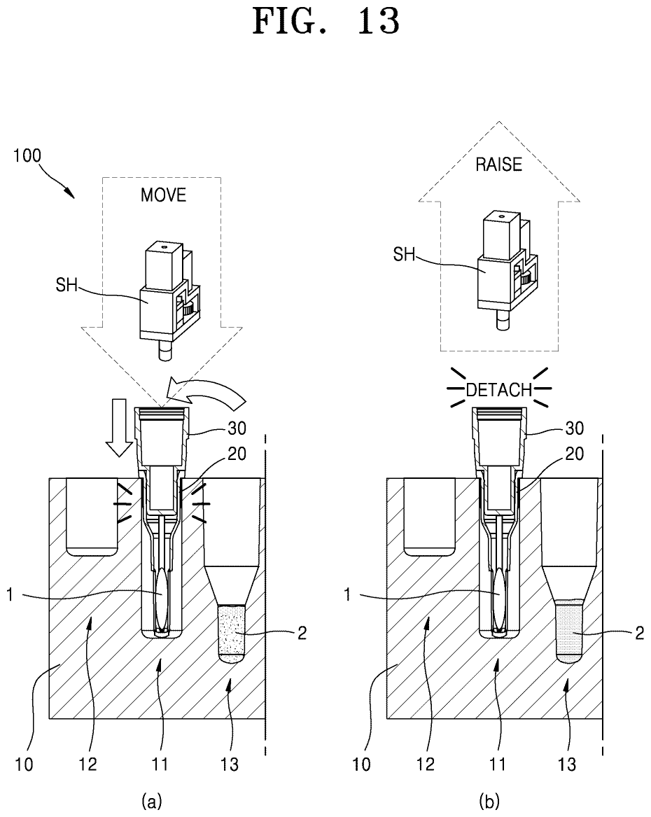

Then, for example, the spin head SH of the robotic device may be moved from the buffer chamber 13 to the extraction tip accommodator 11 to temporarily store the extraction tip 20 and the spin cover 30 in the extraction tip accommodator 11 before being discarded as shown in (a) of FIG. 13, and the spin head SH may be raised and detached from the spin cover 30 by using an additional device such as a clamp or a finger arm as shown in (b) of FIG. 13.

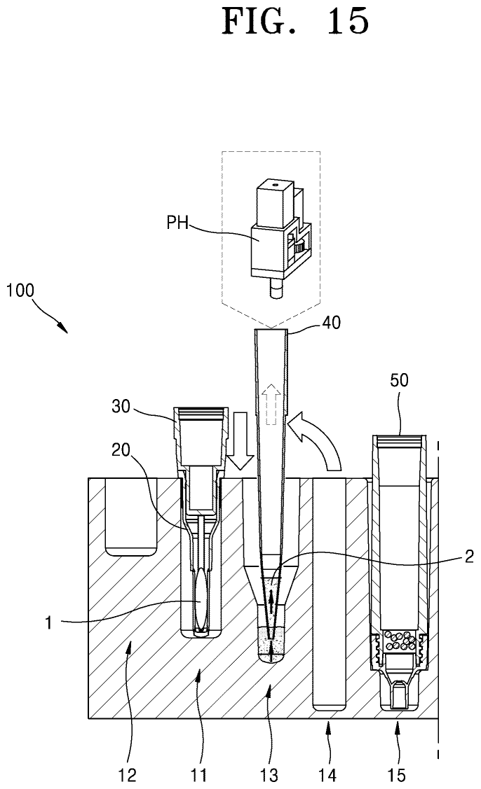

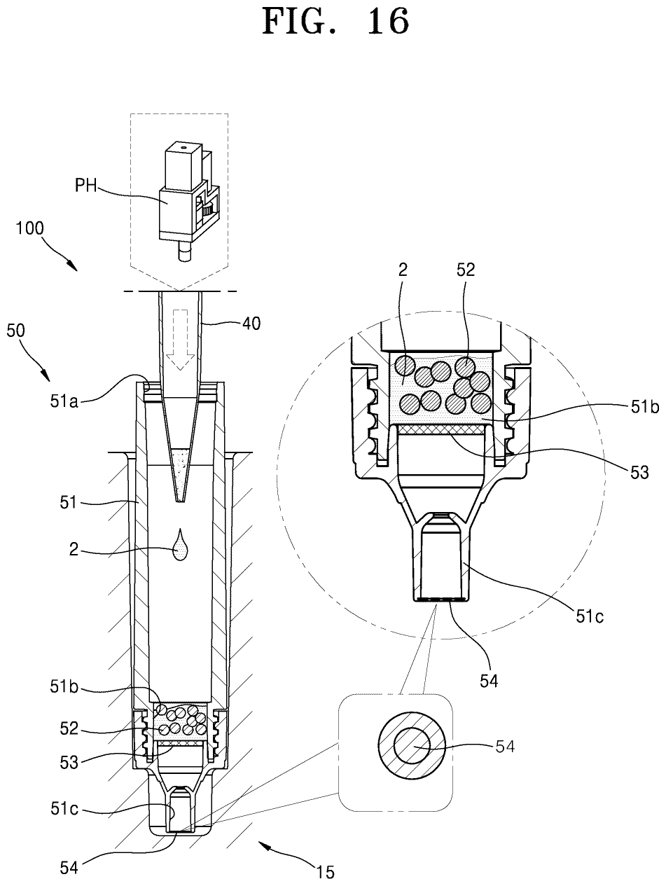

Then, for example, the pump head PH of the robotic device may be attached to the dispensing tip 40 as shown in FIG. 14, the dispensing tip 40 may be moved to the buffer chamber 13 to suck the buffer solution 2 accommodating the sample as shown in FIG. 15, and the dispensing tip 40 may be moved to the filter tip accommodator 15 to dispense the buffer solution 2 accommodating the sample to the filter tip 50 as shown in FIG. 16.

Herein, for example, as shown in FIG. 16, the filter tip 50 may include a filter tip body 51 having a mouth 51a provided at the top to insert a front end of the dispensing tip 40, an accommodator 51b provided inside to accommodate the buffer solution 2, and a releaser 51c provided at the bottom to release the buffer solution 2, a plurality of beads 52 mounted in the accommodator 51b to agitate the buffer solution 2, a mesh filter 53 mounted between the accommodator 51b and the releaser 51c, and the temporary sealing member 54 for temporarily sealing the releaser 51c.

Therefore, as shown in FIG. 16, due to the temporary sealing member 54, although the dispensing tip 40 dispenses the buffer solution 2 to the filter tip 50, the buffer solution 2 may be accommodated in the accommodator 51b of the filter tip 50 without leaking downward from the releaser 51c.

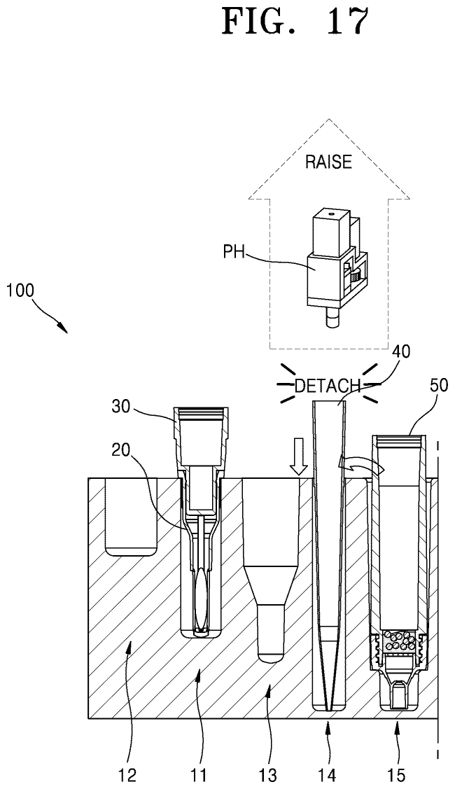

Then, for example, as shown in FIG. 17, to discard the dispensing tip 40, the pump head PH of the robotic device may move and temporarily store the dispensing tip 40 to and in the dispensing tip accommodator 14.

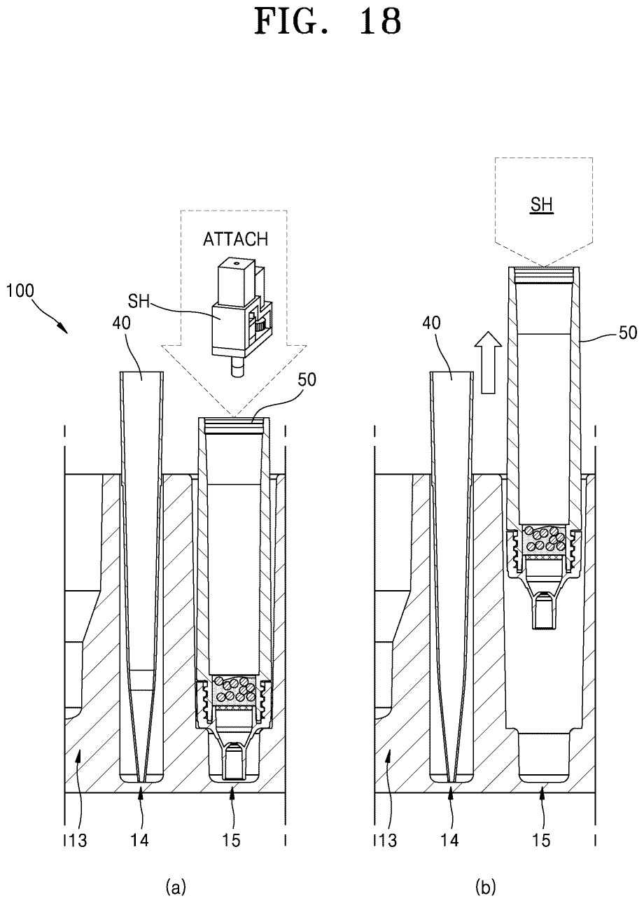

Then, for example, the spin head SH of the robotic device may be coupled with the filter tip 50 as shown in (a) of FIG. 18, and raise the filter tip 50 to be sufficiently spaced apart from the filter tip accommodator 15 as shown in (b) of FIG. 18.

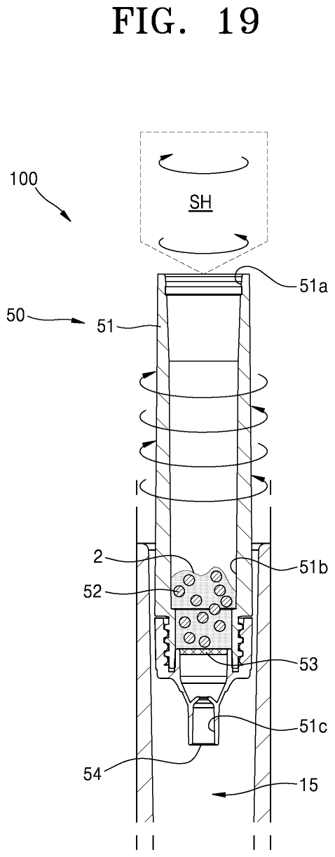

Then, for example, as shown in FIG. 19, the spin head SH may repeatedly rotate the filter tip 50 clockwise and counterclockwise to sufficiently agitate the buffer solution 2 by using the beads 52.

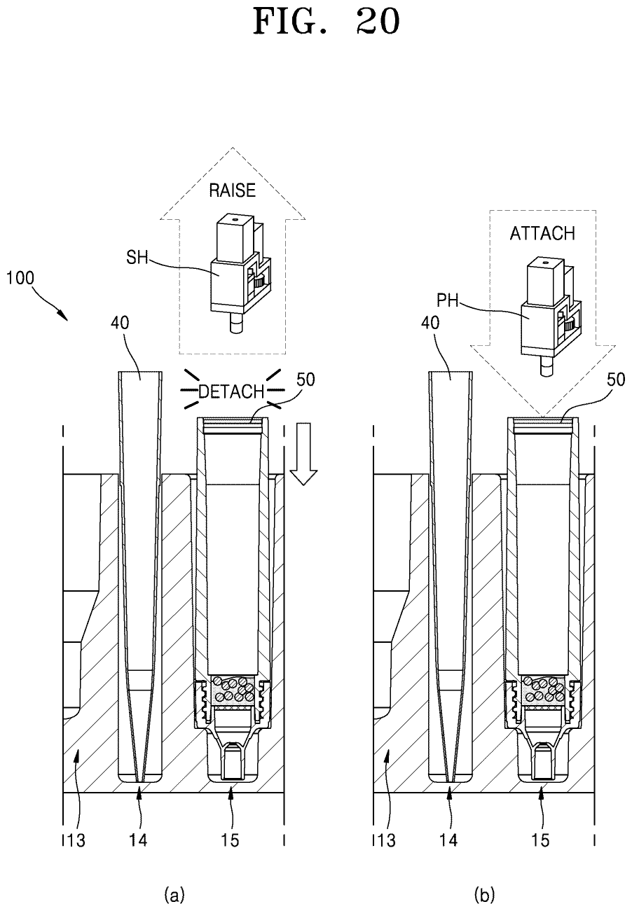

Then, for example, the spin head SH may be raised and detached from the filter tip 50 as shown in (a) of FIG. 20, and then the pump head PH may be lowered and coupled with the filter tip 50 as shown in (b) of FIG. 20.

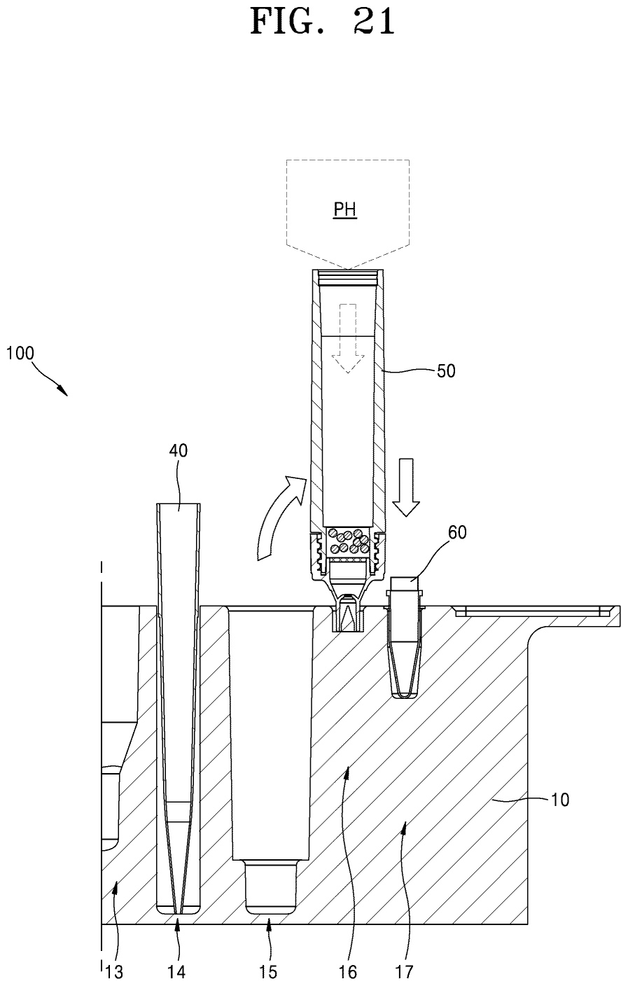

Then, for example, as shown in FIG. 21, the temporary sealing member 54 temporarily sealed to the releaser 51c of the filter tip 50 may be broken or removed by using the sharp part 16 of the cartridge body 10. for example, the pump head PH may raise and release the filter tip 50 from the filter tip accommodator 15, move the filter tip 50 to above the sharp part 16, and then lower and press the filter tip 50 against the sharp part 16 to break or remove the temporary sealing member 54.

In this case, the suction pressure of the pump head PH may be adjusted or maintained to prevent the buffer solution 2 accommodated in the filter tip 50 from leaking downward.

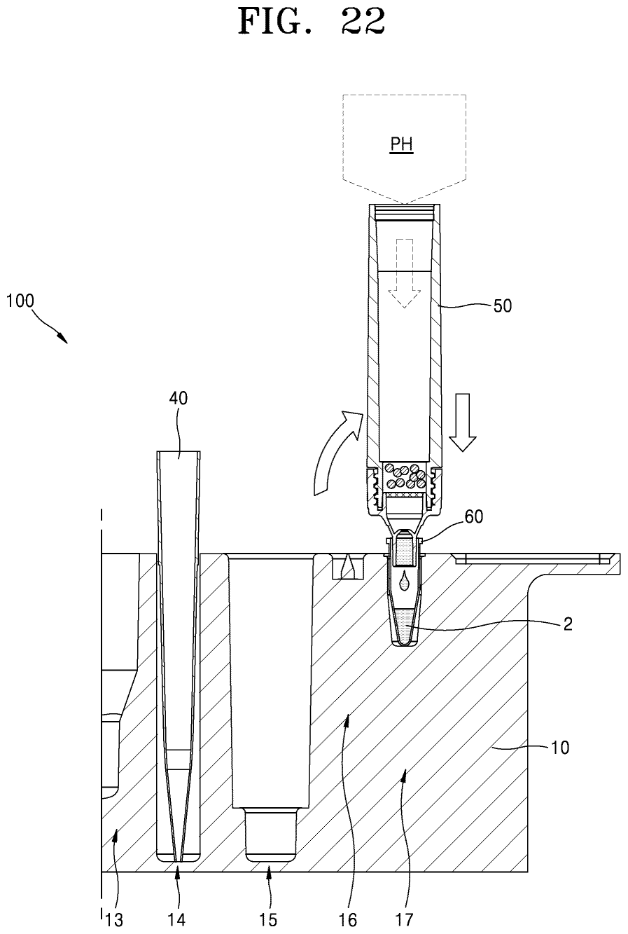

Then, for example, as shown in FIG. 22, the pump head PH may move the filter tip 50 to the collection tube accommodator 17, and press the filter tip 50 to inject the buffer solution 2 into the final solution collection tube 60.

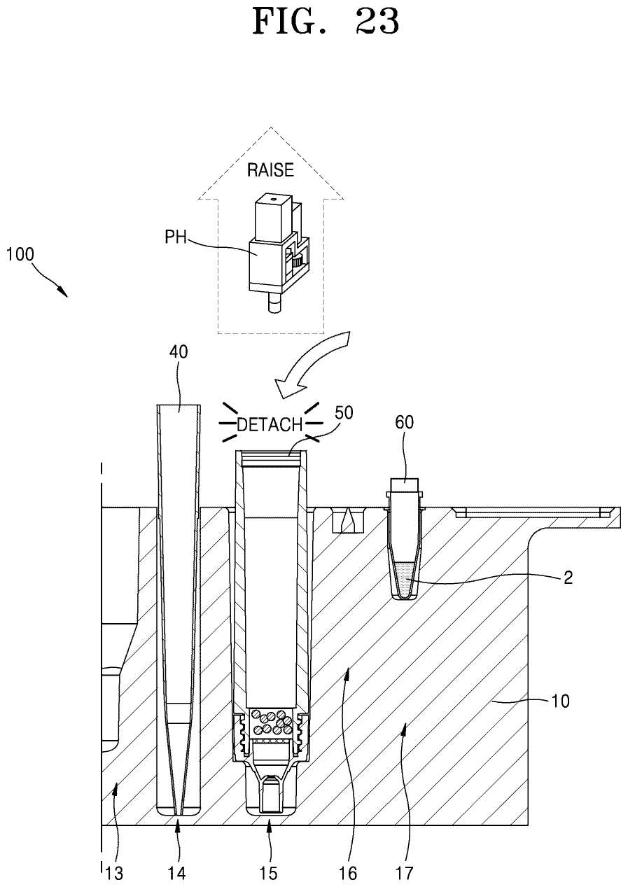

Then, for example, as shown in FIG. 23, to discard the filter tip 50, the pump head PH may move and temporarily store the filter tip 50 to and in the filter tip accommodator 15.

Therefore, according to the present invention, a series of pretreatment processes for immersing the sample collected by the collection member 1 in the buffer solution 2, and extracting, agitating, and dispensing the buffer solution 2 may be performed automatically and very rapidly within a single collected sample extraction cartridge 100, and pretreatment may be performed very hygienically by discarding or incinerating all used components at a time after the processes are completed.

However, the series of collected sample extraction processes are not limited to the illustrations and may be modified or changed by one of ordinary skill in the art without departing from the scope of the present invention.

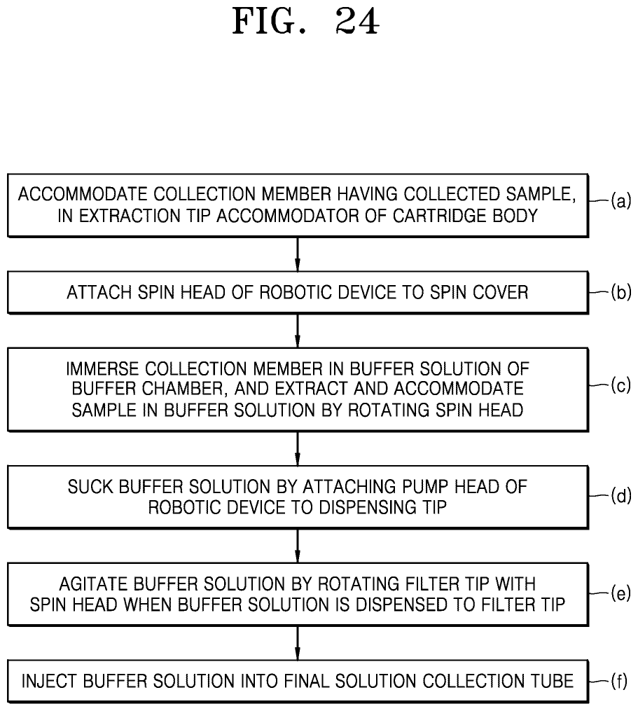

FIG. 24 is a flowchart of a collected sample extraction method according to embodiments of the present invention.

As shown in FIGS. 1 to 24, the collected sample extraction method according to embodiments of the present invention may include (a) accommodating the collection member 1 having collected the sample, in the extraction tip accommodator 11 of the cartridge body 10, (b) attaching the spin head SH of the robotic device to the spin cover 30, (c) immersing the collection member 1 in the buffer solution 2 of the buffer chamber 13 by coupling the spin head SH of the robotic device having the spin cover 30 with the extraction tip 20, and extracting and accommodating the sample in the buffer solution 2 by rotating the spin head SH, (d) sucking the buffer solution 2 accommodating the sample by attaching the pump head PH of the robotic device to the dispensing tip 40, (e) agitating the buffer solution 2 by coupling the spin head SH with the filter tip 50 to rotate the filter tip 50, for example, repeatedly clockwise and counterclockwise, when the dispensing tip 40 dispenses the buffer solution 2 accommodating the sample to the filter tip 50, and (f) injecting the buffer solution 2 accommodating the sample into the final solution collection tube 60.

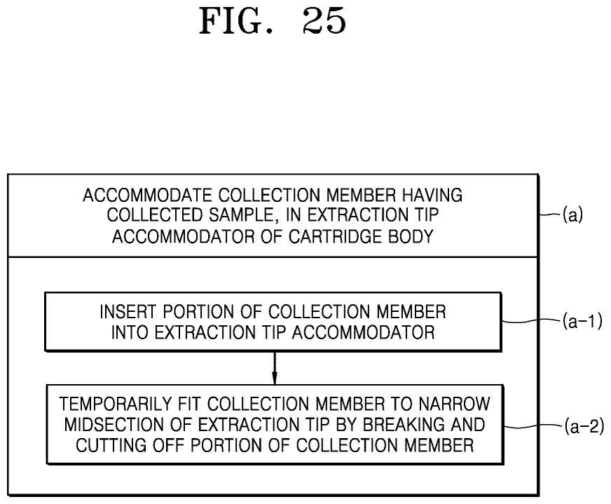

FIG. 25 is a detailed flowchart of step (a) of the collected sample extraction method of FIG. 24.

As shown in FIGS. 1 to 25, step (a) may include (a-1) inserting a portion of the collection member 1 into the extraction tip 20 accommodated in the extraction tip accommodator 11, and (a- 2) temporarily fitting the collection member 1 to the narrow midsection 23 of the extraction tip 20 by breaking and cutting off a portion of the collection member 1.

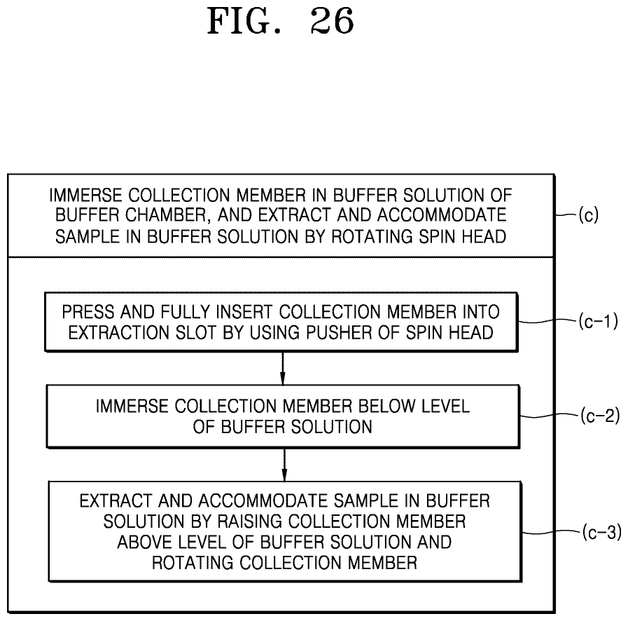

FIG. 26 is a detailed flowchart of step (c) of the collected sample extraction method of FIG. 24.

As shown in FIGS. 1 to 26, step (c) may include (c-1) pressing and fully inserting the collection member 1 into the extraction slot 24 of the extraction tip 20 by using the pusher 32 of the spin head SH, (c-2) immersing the collection member 1 below the level of the buffer solution 2 of the buffer chamber 13, and (c-3) extracting and accommodating the sample in the buffer solution 2 by raising the collection member 1 above the level of the buffer solution 2 of the buffer chamber 13 and rotating the collection member 1.

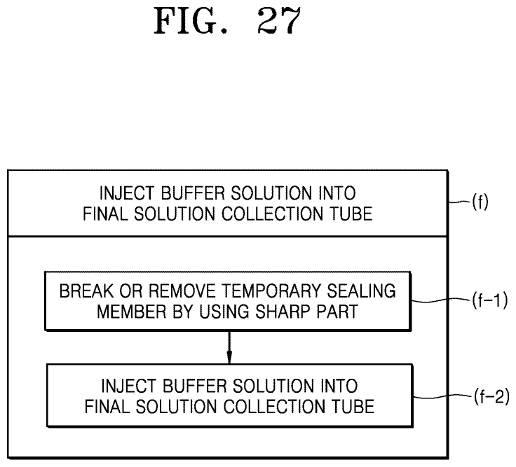

FIG. 27 is a detailed flowchart of step (f) of the collected sample extraction method of FIG. 24.

As shown in FIGS. 1 to 27, step (f) may include (f-1) breaking or removing the temporary sealing member 54 temporarily sealed to the releaser 51c of the filter tip 50, by using the sharp part 16, and (f-2) injecting the buffer solution 2 into the final solution collection tube 60 when the pump head PH is coupled with the filter tip 50 to break or remove the temporary sealing member 54.

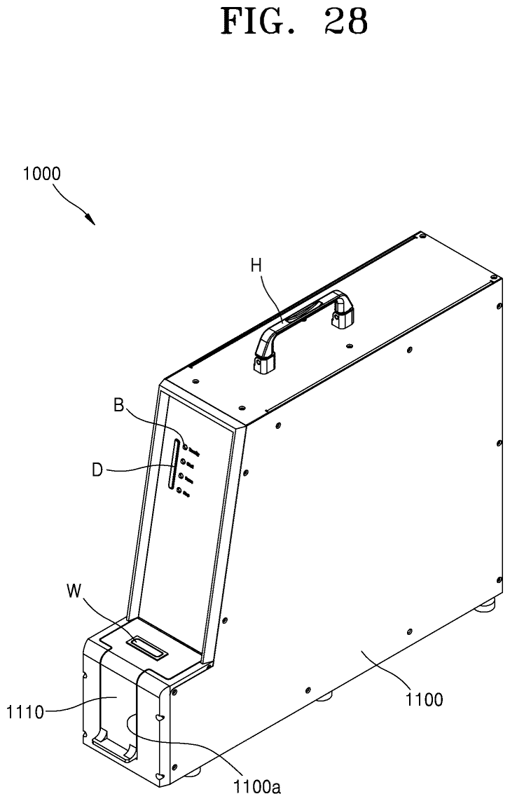

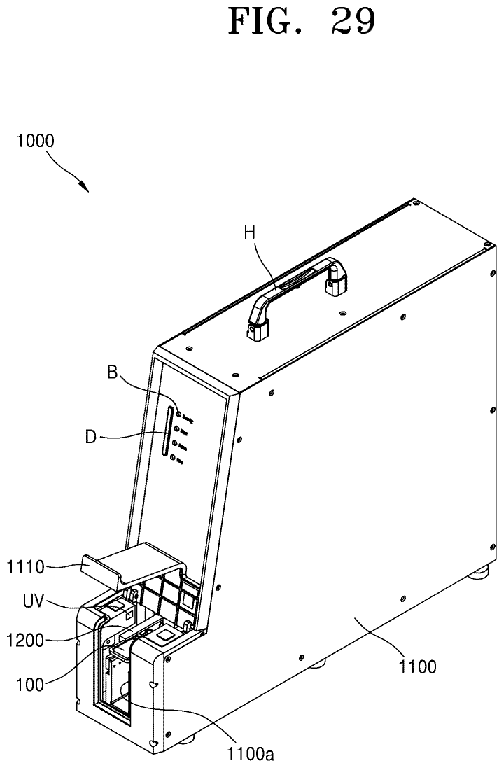

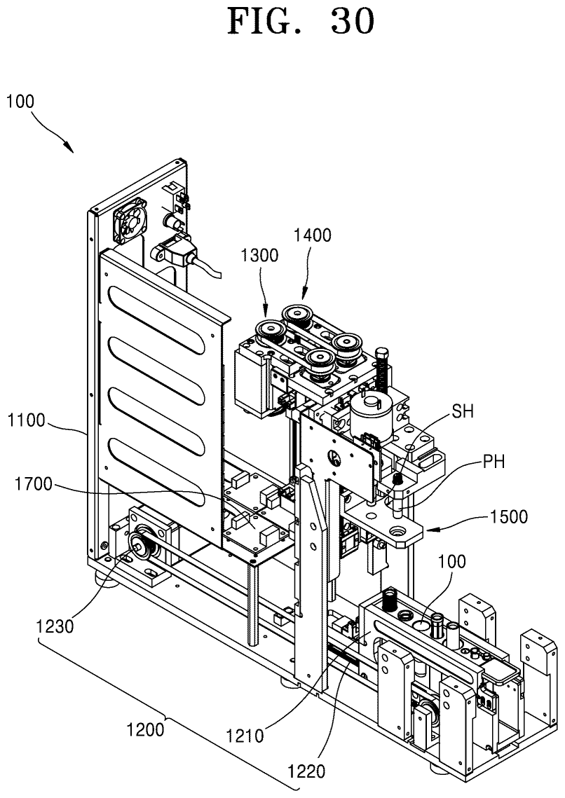

FIG. 28 is an external perspective view of a collected sample pretreatment apparatus 1000 according to embodiments of the present invention, FIG. 29 is an external perspective view showing a door open state of the collected sample pretreatment apparatus 1000 of FIG. 28, and FIG. 30 is an internal perspective view of the collected sample pretreatment apparatus 1000 of FIG. 28.

As shown in FIGS. 28 to 30, the collected sample pretreatment apparatus 1000 according to embodiments of the present invention may mainly include a housing 1100, a cartridge mounting device 1200 for holding the cartridge 100, a spin drive device 1300, a pump drive device 1400, and a tip removal device 1500.

Herein, the cartridge 100 may include the collected sample extraction cartridge 100 of FIGS. 1 to 27 for extracting a sample collected by the collection member 1, and the collection member 1 may include various collectors capable of collecting a sample, e.g., a swab.

The housing 1100 is a kind of box-shaped structure having an accommodation space inside, and may have a hinged door 1110 mounted at front to selectively open or close a cartridge inlet 1100a provided at front, a handle H provided on top for carrying, an ultraviolet (UV) germicidal lamp UV mounted inside for disinfection after sample extraction, command input buttons B and display device D mounted on a front surface, and a window W provided to check the status of the cartridge 100 inside.

Therefore, the collected sample pretreatment apparatus 1000 may be easily carried by a user using the handle H, the cartridge 100 may be instantly pretreated on site, the cartridge 100 may be spatially isolated from the outside by opening the hinged door 1110, mounting the cartridge 100 through the inlet 1100a in the cartridge mounting device 1200 mounted inside the housing 1100, and then closing the hinged door 1110, and pretreatment processes may be automatically performed by pressing the command input buttons B, and monitored on the display device D and with naked eyes through the window W.

In addition, all processes may be performed very hygienically by sterilizing the cartridge 100 or the inside of the housing 1100 with the UV germicidal lamp UV after pretreatment is completed.

However, the housing 1100 or the door 1110 is not limited to the illustrations and may be provided in a wide variety of forms considering the test environment, specifications, or design elements.

A blower fan, an odor remover, an air purifier, an air conditioner including a filter (e.g., a high-efficiency particulate air (HEPA) filter), an air conditioner for controlling temperature or humidity, or the like may be additionally mounted on the housing 1100 to provide a pleasant environment and prevent odors or contamination.

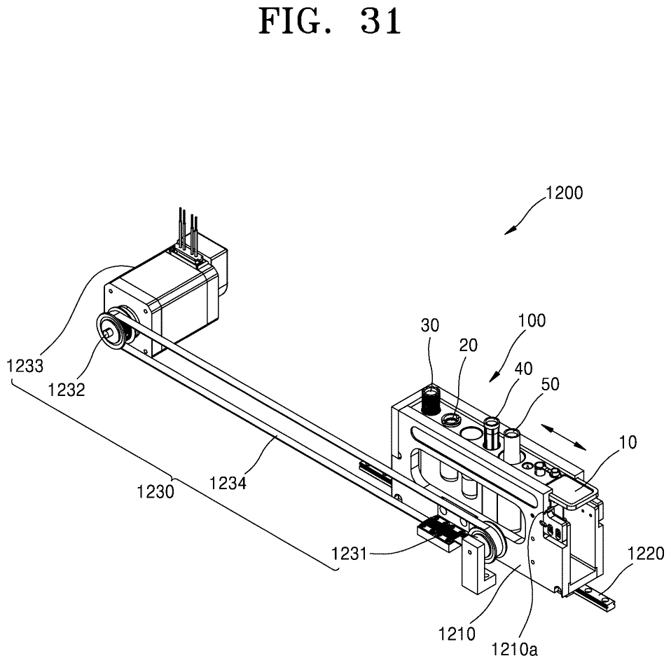

FIG. 31 is a perspective view of the cartridge mounting device 1200 of the collected sample pretreatment apparatus 1000 of FIG. 28.

As shown in FIG. 31, the cartridge mounting device 1200 may be a device mounded inside the housing 1100 to hold the cartridge 100.

The cartridge mounting device 1200 may include a cartridge holder 1210 for holding the cartridge 100, a cartridge guide rail 1220 for guiding the cartridge holder 1210, and a holder moving device 1230 for moving the cartridge holder 1210 along the cartridge guide rail 1220 to move the cartridge 100 mounted in the cartridge holder 1210 to a position corresponding to the spin drive device 1300 or a position corresponding to the pump drive device 1400.

Specifically, for example, the holder moving device 1230 may include a driven pulley 1231 mounted to rotate freely at a side of the housing 1100 or a frame, a drive pulley 1232 mounted to rotate freely at another side of the housing 1100 or the frame, a holder drive motor 1233 for rotating the drive pulley 1232, and a belt 1234 having a side fixed to the cartridge holder 1210, and wound between the driven pulley 1231 and the drive pulley 1232 to move along a track.

Therefore, when the holder drive motor 1233 rotates the drive pulley 1232 clockwise or counterclockwise, the belt 1234 wound between the driven pulley 1231 and the drive pulley 1232 may be moved to move the cartridge holder 1210 connected to the belt 1234 along the cartridge guide rail 1220 and thus the cartridge 100 mounted in the cartridge holder 1210 may be moved forward or backward to the position corresponding to the spin drive device 1300 or the position corresponding to the pump drive device 1400.

However, the holder moving device 1230 is not limited to the above-described belt-pulley combination, and a wide variety of moving devices, e.g., rack gear-pinion gear combinations, chain-sprocket wheel combinations, movable plate-screw rod combinations, and linear motor- wire-pulley combinations, are all applicable.

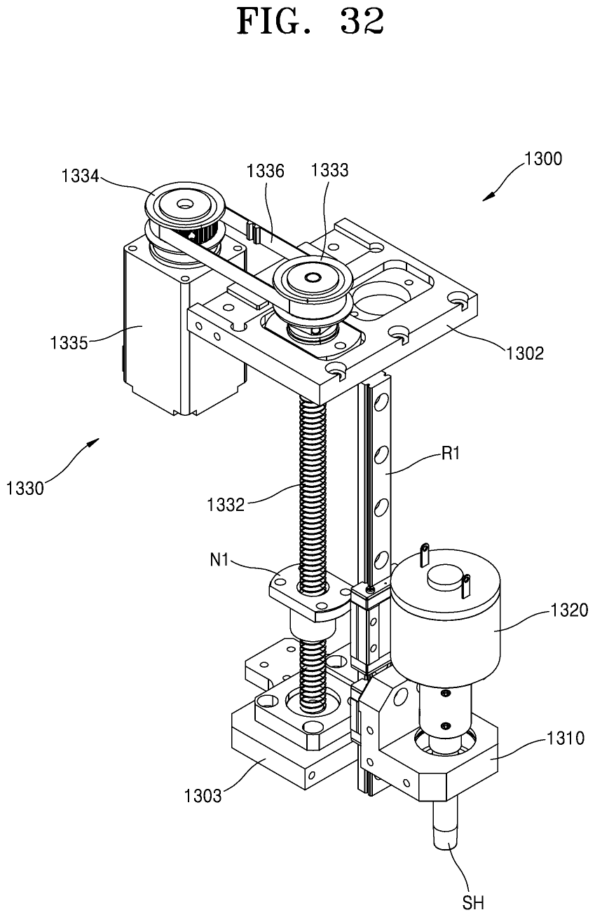

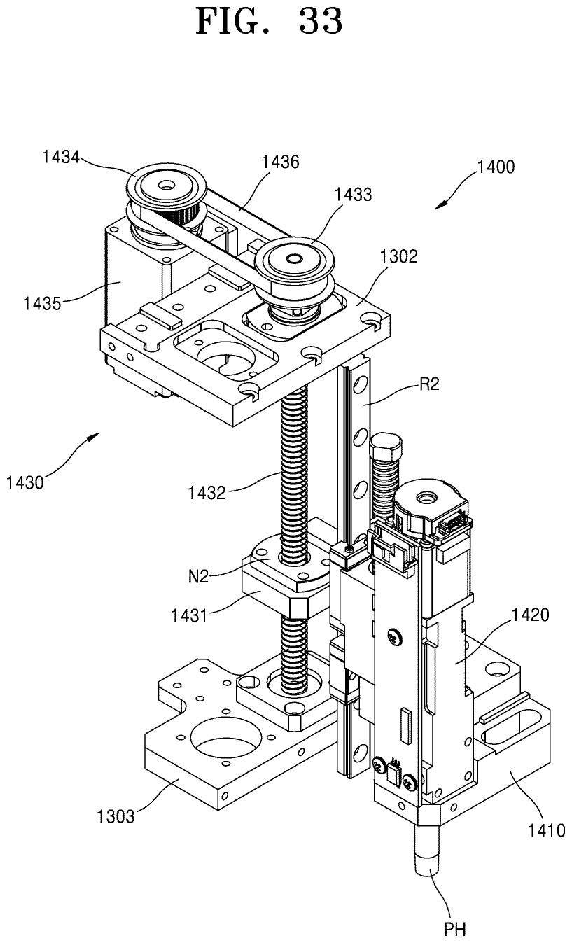

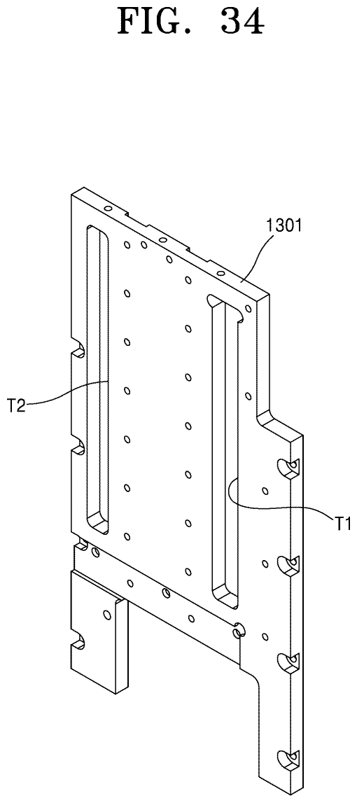

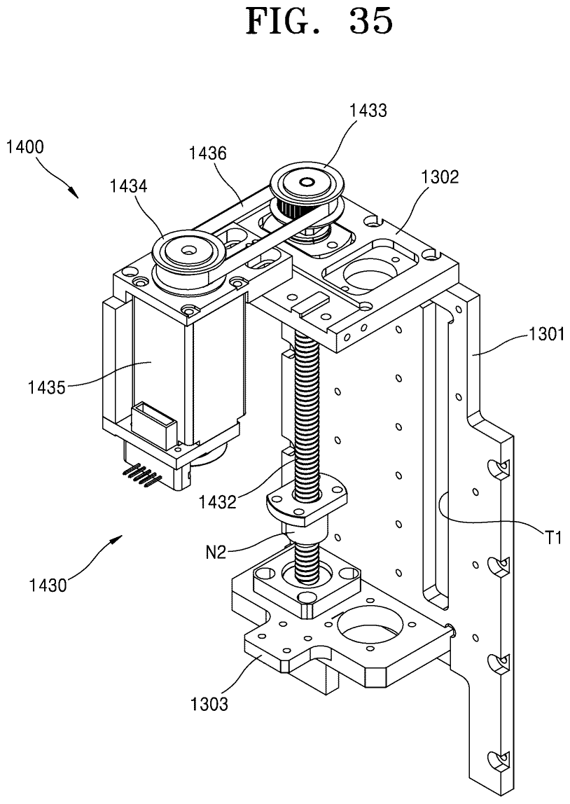

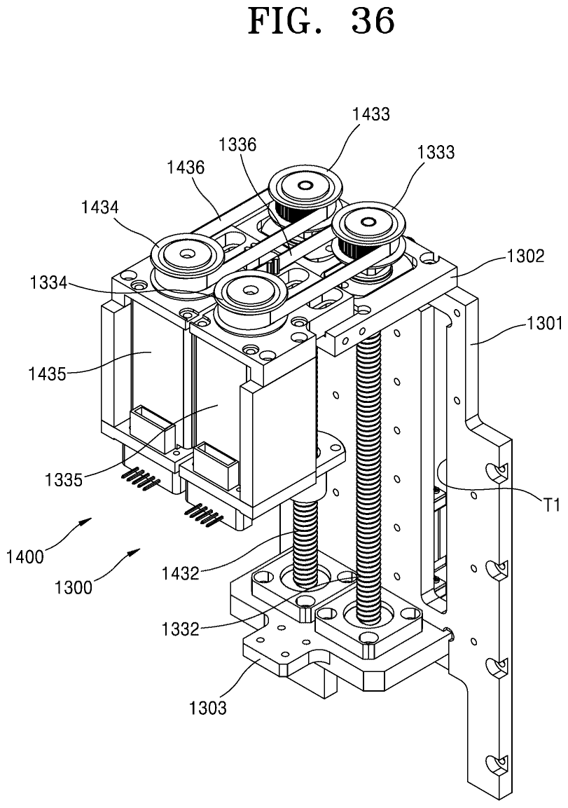

FIG. 32 is a perspective view of the spin drive device 1300 of the collected sample pretreatment apparatus 1000 of FIG. 28, FIG. 33 is a perspective view of the pump drive device 1400 of the collected sample pretreatment apparatus 1000 of FIG. 28, FIG. 34 is a rear perspective view of a main base 1301 of the collected sample pretreatment apparatus 1000 of FIG. 28, and FIGS. 35 to 37 are rear perspective views of the spin drive device 1300 and the pump drive device 1400 of the collected sample pretreatment apparatus 1000 of FIG. 28.

Initially, as shown in FIG. 32, the spin drive device 1300 may be a device mounted inside the housing 1100 and coupled with a spin tip which needs to be spun, e.g., the spin cover 30 (see FIG. 31) or filter tip 50 (see FIG. 31) provided in the cartridge 100 or the cartridge mounting device 1200, to rotate the spin tip.

The spin drive device 1300 may include a first platform 1310 mounted to be raised or lowered along a first rail R1 mounted at a front side of the main base 1301 (see FIG. 34), the spin head SH rotatably mounted on the first platform 1310 and coupled with the spin cover 30 or filter tip 50 coupled with the extraction tip 20 including the collection member 1, e.g., the cut swab, of the cartridge 100, a spin motor 1320 mounted on the first platform 1310 to spin the spin head SH, and a first platform drive device 1330 for raising or lowering the first platform 1310.

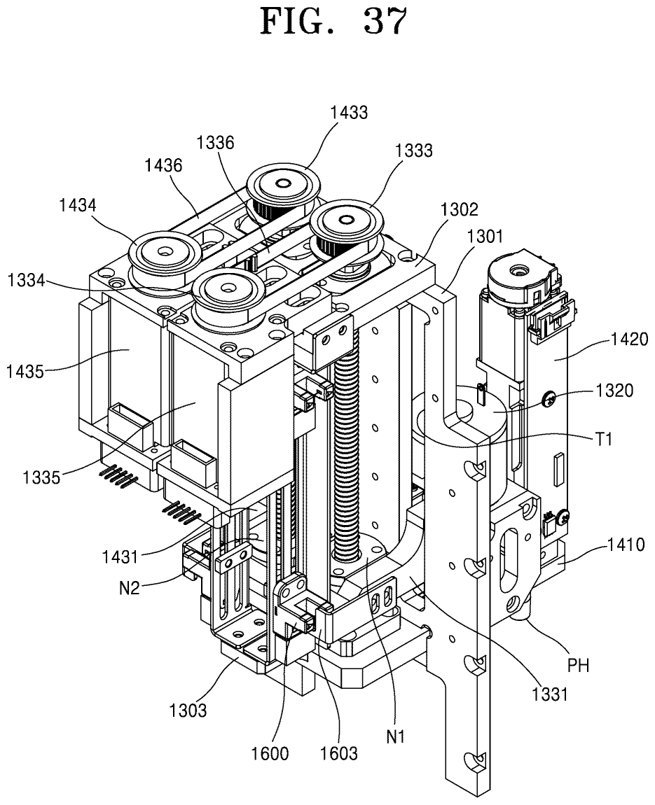

Specifically, for example, the first platform drive device 1330 may include a first extension 1331 (see FIG. 37) extending from the first platform 1310 to penetrate through a first through hole T1 vertically formed in the main base 1301, and having a first nut member N1 mounted thereon, a first screw rod 1332 mounted to rotate freely behind the main base 1301, and screw-penetrating through the first nut member N1, a first driven pulley 1333 mounted on the first screw rod 1332, a first drive pulley 1334 rotatably mounted on an extension base 1302 connected to the main base 1301, a first platform drive motor 1335 mounted on the extension base 1302 to rotate the first drive pulley 1334, and a first belt 1336 wound between the first drive pulley 1334 and the first driven pulley 1333 to transmit rotational force of the first drive pulley 1334 to the first driven pulley 1333.

Therefore, when the first platform drive motor 1335 rotates the first drive pulley 1334 clockwise or counterclockwise, the tension of the first belt 1336 wound between the first drive pulley 1334 and the first driven pulley 1333 may be transmitted to the first driven pulley 1333 to rotate the first screw rod 1332 clockwise or counterclockwise together with the first driven pulley 1333, and when the first nut member N1 is screw-raised or-lowered along the first screw rod 1332, the first platform 1310 may be raised or lowered together with the first extension 1331 (see FIG. 37) to raise or lower the spin head SH.

As such, the spin head SH may be lowered to be coupled with the spin cover 30 or filter tip 50 coupled with the extraction tip 20 including the collection member 1, e.g., the cut swab, of the cartridge 100, and then raised to a certain height to spin the spin cover 30 or the filter tip 50 by using the spin motor 1320.

However, the first platform drive device 1330 is not limited to the above-described belt-pulley combination, and a wide variety of moving devices, e.g., rack gear-pinion gear combinations, chain-sprocket wheel combinations, movable plate-screw rod combinations, and linear motor-wire-pulley combinations, are all applicable.

As shown in FIG. 33, the pump drive device 1400 may be a device mounted inside the housing 1100 and coupled with the dispensing tip 40 (see FIG. 31) provided in the cartridge 100 or the cartridge mounting device 1200 to dispense the buffer solution 2 by using the dispensing tip 40.

The pump drive device 1400 may include a second platform 1410 mounted to be raised or lowered along a second rail R2 mounted at another front side of the main base 1301, the pump head PH mounted on the second platform 1410 to enable dispensing and coupled with the dispensing tip 40 (see FIG. 31) or the filter tip 50 (see FIG. 31), a dispensing pump 1420 mounted on the second platform 1410 and connected to the pump head PH to suck or dispense the buffer solution 2, and a second platform drive device 1430 for raising or lowering the second platform 1410.

Specifically, for example, the second platform drive device 1430 may include a second extension 1431 (see FIG. 37) extending from the second platform 1410 to penetrate through a second through hole T2 vertically formed in the main base 1301 (see FIG. 34), and having a second nut member N2 mounted thereon, a second screw rod 1432 mounted to rotate freely behind the main base 1301, and screw-penetrating through the second nut member N2, a second driven pulley 1433 mounted on the second screw rod 1432, a second drive pulley 1434 rotatably mounted on the extension base 1302 connected to the main base 1301, a second platform drive motor 1435 mounted on the extension base 1302 to rotate the second drive pulley 1434, and a second belt 1436 wound between the second drive pulley 1434 and the second driven pulley 1433 to transmit rotational force of the second drive pulley 1434 to the second driven pulley 1433.

Therefore, when the second platform drive motor 1435 rotates the second drive pulley 1434 clockwise or counterclockwise, the tension of the second belt 1436 wound between the second drive pulley 1434 and the second driven pulley 1433 may be transmitted to the second driven pulley 1433 to rotate the second screw rod 1432 clockwise or counterclockwise together with the second driven pulley 1433, and when the second nut member N2 is screw-raised or -lowered along the second screw rod 1432, the second platform 1410 may be raised or lowered together with the second extension 1431 (see FIG. 37) to raise or lower the pump head PH.

As such, the pump head PH may be lowered to be coupled with the dispensing tip 40 (see FIG. 31) or the filter tip 50 (see FIG. 31), and then raised to a certain height to dispense the buffer solution 2 by using the dispensing pump 1420 to a desired position of the cartridge 100 which is mounted in the cartridge mounting device 1200 to move forward or backward.

However, the second platform drive device 1430 is not limited to the above-described belt-pulley combination, and a wide variety of moving devices, e.g., rack gear-pinion gear combinations, chain-sprocket wheel combinations, movable plate-screw rod combinations, and linear motor-wire-pulley combinations, are all applicable.

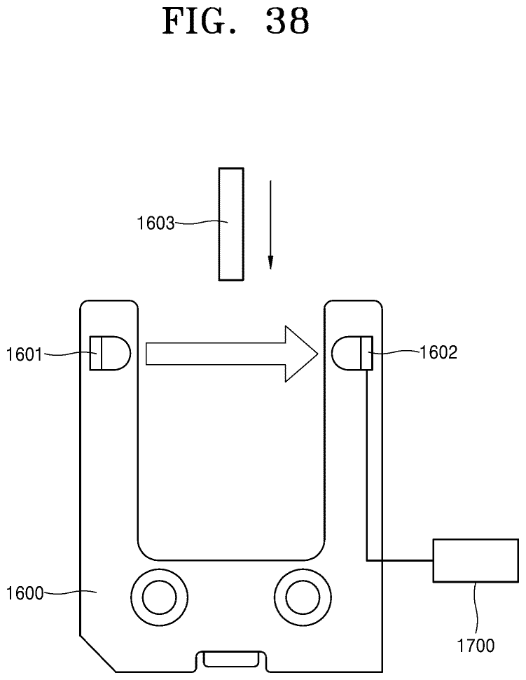

FIG. 38 is a conceptual view of a position detection sensor 1600 of the collected sample pretreatment apparatus 1000 of FIG. 37.

As shown in FIGS. 37 and 38, the collected sample pretreatment apparatus 1000 according to embodiments of the present invention may further include the position detection sensor 1600 mounted on a horizontal frame 1303 mounted on the main base 1301, to detect a raised or lowered position of a detection target object 1603 provided on each of the first and second extensions 1331 and 1431 (see FIG. 37), by using a light emitter 1601 and a light receiver 1602, and a controller 1700 for receiving a position signal from the position detection sensor 1600 to apply a control signal to the first or second platform drive device 1330 or 1430.

The position detection sensor 1600 is a kind of limit sensor capable of detecting a height of the first or second platform drive device 1330 or 1430 to raise or lower the first or second platform drive device 1330 or 1430 to a preset height, and the controller 1700 may perform pretreatment processes in a preset order by controlling the first and second platform drive devices 1330 and 1430 by using the position detection sensor 1600.

Therefore, as shown in FIG. 38, when the detection target object 1603 provided on the first or second extension 1331 or 1431 is raised or lowered to the height of the position detection sensor 1600, the detection target object 1603 may block an optical path between the light emitter 1601 and the light receiver 1602 to interrupt an optical signal received by the light receiver 1602, the controller 1700 may apply an up/down control signal to the first or second platform drive device 1330 or 1430 by detecting the change in the received optical signal.

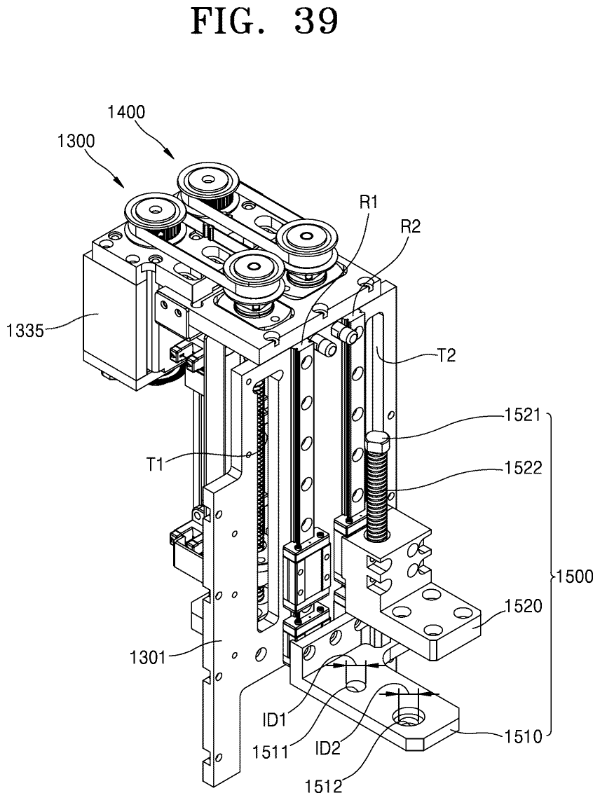

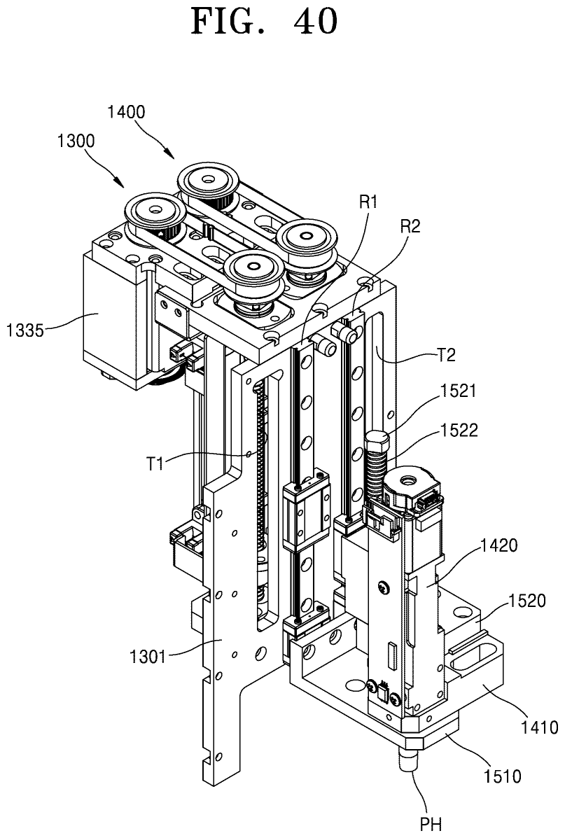

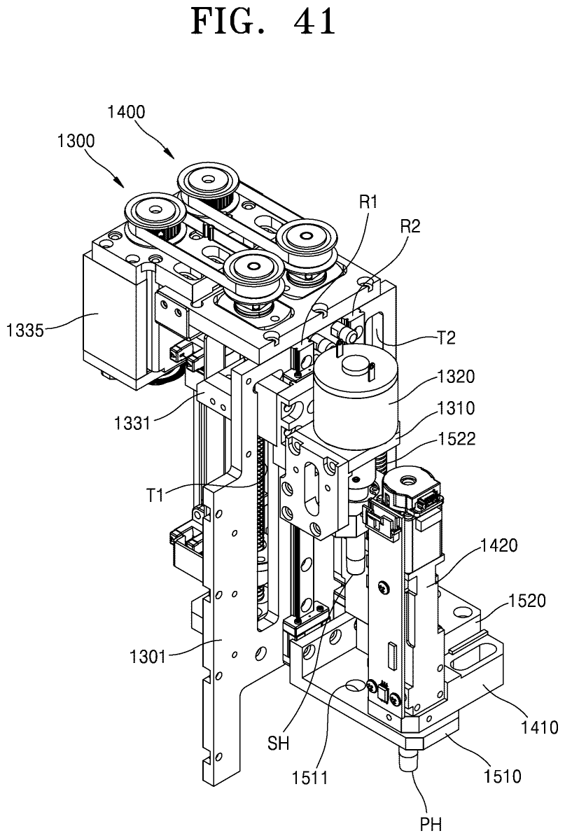

FIGS. 39 to 41 are perspective views of a tip removal device 1500 of the collected sample pretreatment apparatus 1000 of FIG. 28.

As shown in FIGS. 39 to 41, the tip removal device 1500 may be a device mounted inside the housing 1100 to remove the spin tip from the spin drive device 1300 or the dispensing tip 40 from the pump drive device 1400 by using relative motion of the spin drive device 1300 and the pump drive device 1400.

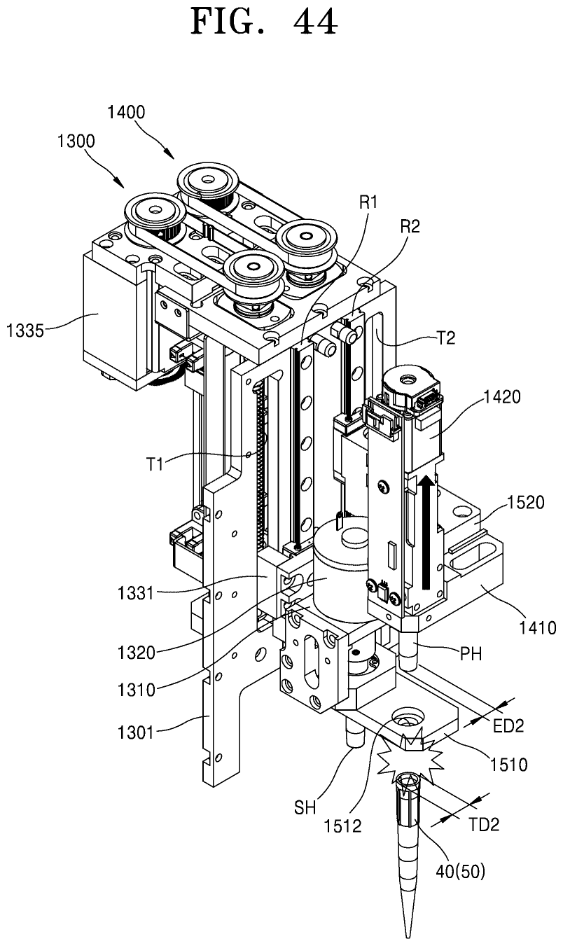

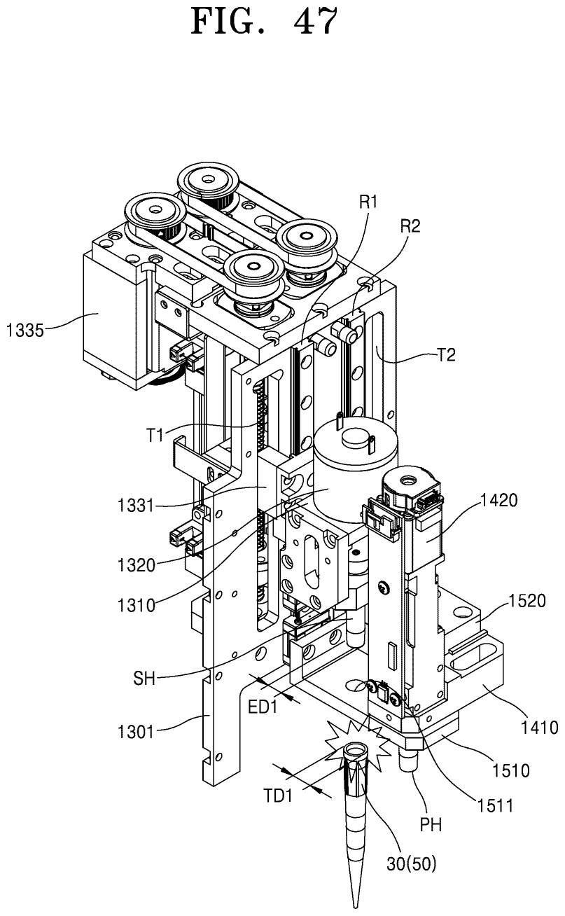

The tip removal device 1500 may include a tip removal block 1510 mounted to be raised or lowered along the first and second rails R1 and R2 to press the spin tip or the dispensing tip 40, a first through hole 1511 provided in a portion of the tip removal block 1510 and having an inner diameter ID1 (see FIG. 39) which is greater than an outer diameter ED1 (see FIG. 47) of the spin head SH to allow the spin head SH to pass downward and which is less than an outer diameter TD1 (see FIG. 47) of the spin tip to remove the spin tip coupled with the spin head SH when the spin head SH passes upward, and a second through hole 1512 provided in another portion of the tip removal block 1510 and having an inner diameter ID2 (see FIG. 39) which is greater than an outer diameter ED2 (see FIG. 44) of the pump head PH to allow the pump head PH to pass downward and which is less than an outer diameter TD2 (see FIG. 44) of the dispensing tip 40 to remove the dispensing tip 40 coupled with the pump head PH when the pump head PH passes upward.

The tip removal device 1500 may further include an elastic support block 1520 mounted to be raised or lowered along the second rail R2, having the second platform 1410 mounted at a side to prevent falling of the tip removal block 1510 and adjust a height of the tip removal block 1510 in conjunction with the second platform 1410, and elastically supporting the tip removal block 1510 by using a spring 1522 of a spring bar 1521 mounted on the tip removal block 1510.

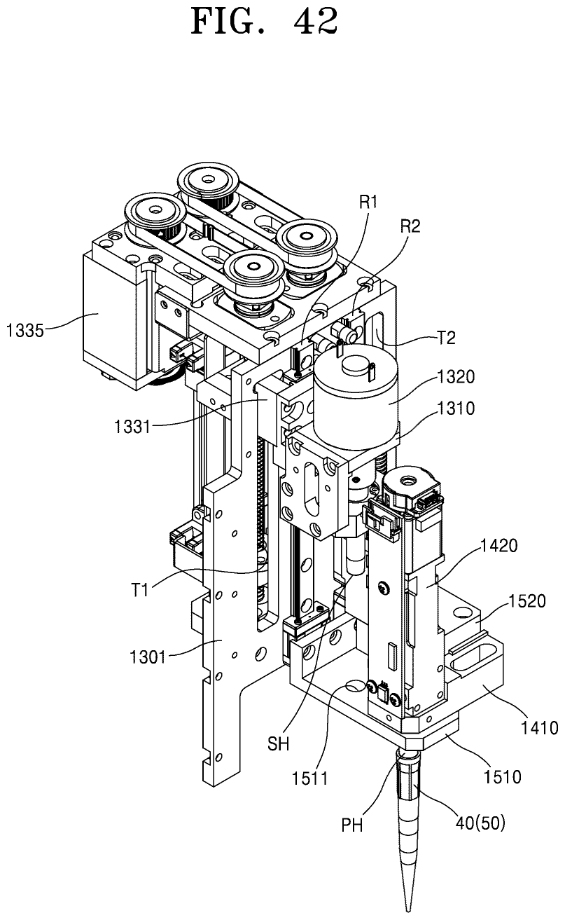

FIGS. 42 to 44 are perspective views showing a dispensing tip removal process of the collected sample pretreatment apparatus 1000 of FIG. 28 step by step.

The dispensing tip removal process of the collected sample pretreatment apparatus 1000 according to embodiments of the present invention will now be described step by step with reference to FIGS. 42 to 44. Initially, as shown in FIG. 42, the pump head PH may be lowered using the pump drive device 1400 and forcibly interference-fitted to the dispensing tip 40 or the filter tip 50, and then raised to a certain height to dispense the buffer solution 2 by using the dispensing pump 1420 to a desired position of the cartridge 100 which is mounted in the cartridge mounting device 1200 to move forward or backward.

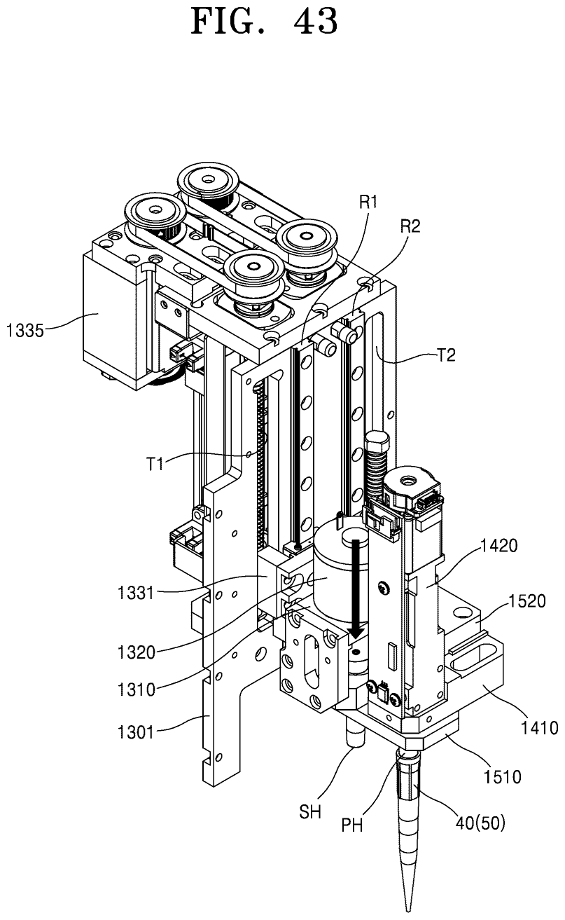

Then, as shown in FIG. 43, to remove the used dispensing tip 40 or filter tip 50 from the pump head PH, the first platform 1310 on which the spin head SH is mounted may be lowered toward the tip removal block 1510 of the tip removal device 1500 by using the spin drive device 1300.

Then, as shown in FIG. 44, when the tip removal block 1510 elastically supported by the elastic support block 1520 is pressed by the lowered first platform 1310, the pressed tip removal block 1510 may press and forcibly remove the dispensing tip 40 or filter tip 50 interference-fitted to the pump head PH and drop the dispensing tip 40 or the filter tip 50 to an original position or a desired position of the cartridge 100.

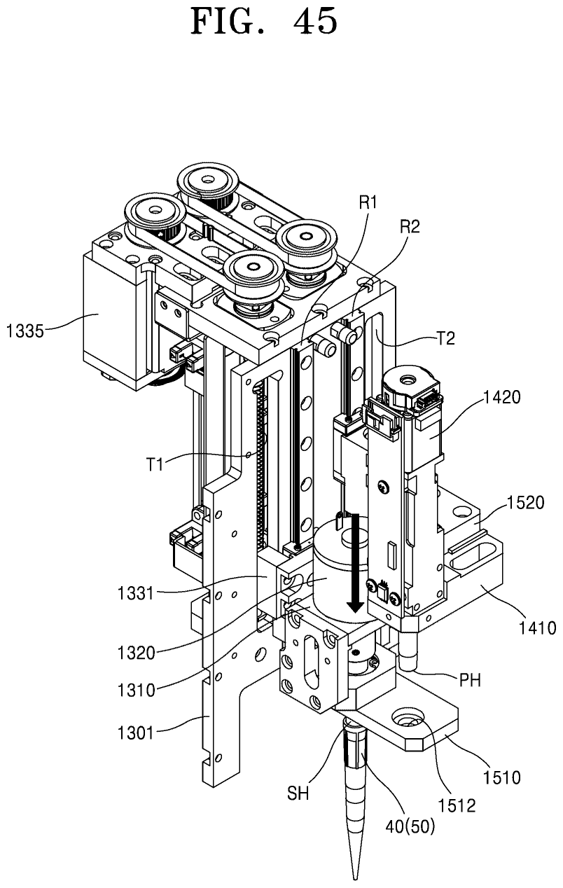

FIGS. 45 to 47 are perspective views showing a spin cover removal process of the collected sample pretreatment apparatus 1000 of FIG. 28 step by step.

The spin cover removal process of the collected sample pretreatment apparatus 1000 according to embodiments of the present invention will now be described step by step with reference to FIGS. 45 to 47. Initially, as shown in FIG. 45, the spin head SH may be lowered using the spin drive device 1300 and forcibly interference-fitted to the spin cover 30 or the filter tip 50, and then raised to a certain height to spin the spin cover 30 or the filter tip 50.

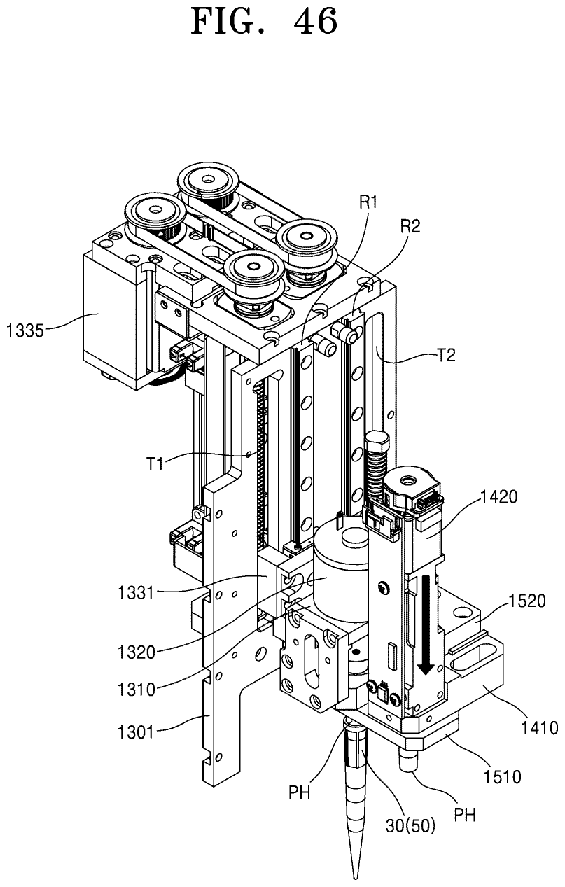

Then, as shown in FIG. 46, to remove the used spin cover 30 or filter tip 50 from the spin head SH, the second platform 1410 on which the pump head PH is mounted may be lowered toward the tip removal block 1510 of the tip removal device 1500 by using the pump drive device 1400.

Then, as shown in FIG. 47, when the tip removal block 1510 elastically supported by the elastic support block 1520 is pressed by the lowered second platform 1410, the pressed tip removal block 1510 may press and forcibly remove the spin cover 30 or filter tip 50 interference-fitted to the spin head SH and drop the spin cover 30 or the filter tip 50 to an original position or a desired position of the cartridge 100.

Thus, according to the present invention, a test may be facilitated by automating all pretreatment processes including not only a spin mode, an extraction mode, a dispensing mode, and an agitation mode of tips mounted in the cartridge 100 but also a tip removal mode for removing used tips from the spin head SH and the pump head PH, and the reliability and uniformity of the test may be significantly increased.

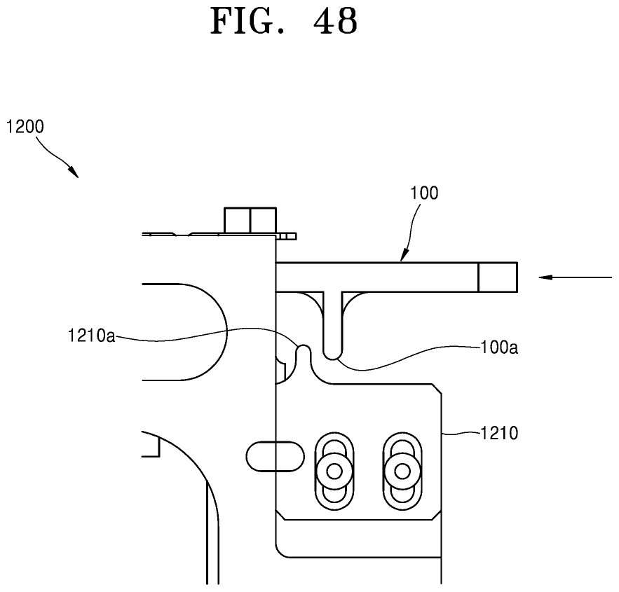

FIGS. 48 to 50 are side views showing a cartridge mounting process of the collected sample pretreatment apparatus 1000 of FIG. 28 step by step.

As shown in FIGS. 48 to 50, in the cartridge mounting device 1200 of the collected sample pretreatment apparatus 1000 according to embodiments of the present invention, a stopper 1210a may be provided on the cartridge holder 1210 so as to be elastically coupled with a protrusion 100a provided on the cartridge 100 when the cartridge 100 is inserted.

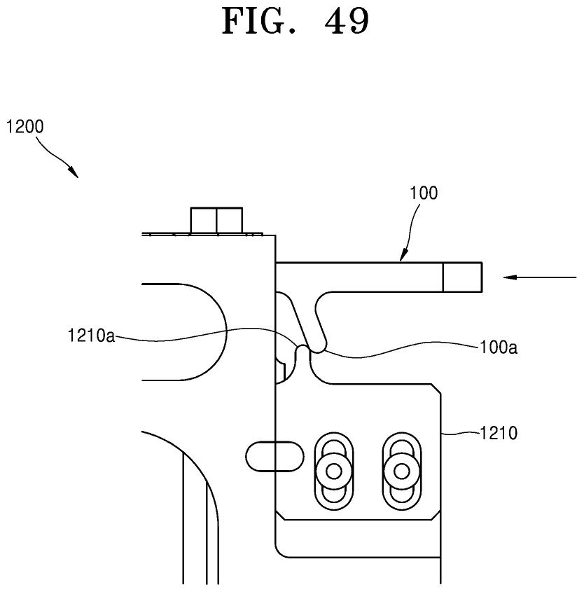

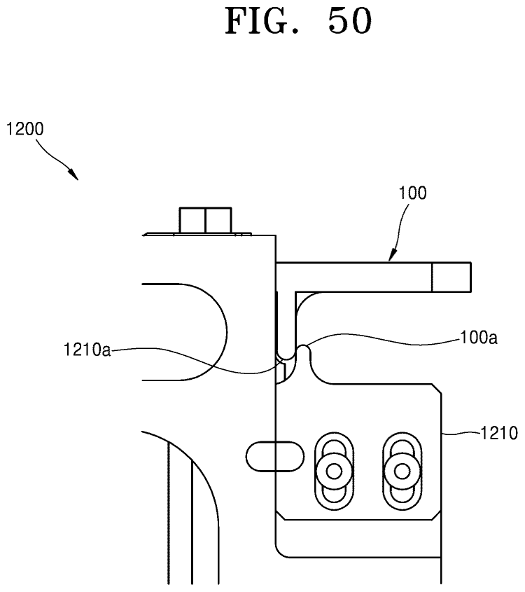

The cartridge mounting process of the collected sample pretreatment apparatus 1000 according to embodiments of the present invention will now be described with reference to FIGS. 48 to 50. Initially, when a user inserts the cartridge 100 into the cartridge holder 1210 of the cartridge mounting device 1200 as shown in FIG. 48, the protrusion 100a provided on the cartridge 100 may be elastically deformed in contact with the stopper 1210a provided on the cartridge holder 1210 as shown in FIG. 49. Then, as shown in FIG. 50, when the user presses the cartridge 100 with more power, the protrusion 100a may pass the stopper 1210a and be firmly and temporarily fixed to the cartridge holder 1210 with a “click” sound.

The stopper 1210a of the cartridge holder 1210 may be provided on a screw-coupled adjustment block so as to adjust a height thereof, and a wide variety of temporary fixing devices based on interference fittings, hook-and-loop tape, screw couplings, magnets, etc. are all applicable between the cartridge 100 and the cartridge holder 1210.

While the present invention has been particularly shown and described with reference to embodiments thereof, it will be understood by one of ordinary skill in the art that various changes in form and details may be made therein without departing from the scope of the present invention as defined by the following claims.

1. A collected sample pretreatment apparatus comprising:
a housing;
a cartridge mounting device mounted inside the housing to hold a cartridge;
a spin drive device mounted in the housing and coupled with a spin tip provided in the cartridge or the cartridge mounting device to rotate the spin tip;
a pump drive device mounted in the housing and coupled with a dispensing tip provided in the cartridge or the cartridge mounting device to dispense a buffer solution by using the dispensing tip; and
a tip removal device mounted in the housing and to remove the spin tip from the spin drive device or the dispensing tip from the pump drive device by using relative motion of the spin drive device and the pump drive device.

2. The collected sample pretreatment apparatus of claim 1, wherein the cartridge mounting device comprises:
a cartridge holder for holding the cartridge;
a cartridge guide rail for guiding the cartridge holder; and
a holder moving device for moving the cartridge holder along the cartridge guide rail to move the cartridge mounted in the cartridge holder to a position corresponding to the spin drive device or a position corresponding to the pump drive device.

3. The collected sample pretreatment apparatus of claim 2, wherein the holder moving device comprises:
a driven pulley mounted to rotate freely at a side of the housing or a frame;
a drive pulley mounted to rotate freely at another side of the housing or the frame;
a holder drive motor for rotating the drive pulley; and
a belt having a side fixed to the cartridge holder, and wound between the driven pulley and the drive pulley to move along a track.

4. The collected sample pretreatment apparatus of claim 1, wherein the spin drive device comprises:
a first platform mounted to be raised or lowered along a first rail mounted at a front side of a main base;
a spin head rotatably mounted on the first platform and coupled with a spin cover or filter tip coupled with an extraction tip comprising a collection member of the cartridge;
a spin motor mounted on the first platform to spin the spin head; and
a first platform drive device for raising or lowering the first platform.

5. The collected sample pretreatment apparatus of claim 4, wherein the first platform drive device comprises:
a first extension extending from the first platform to penetrate through a first through hole vertically formed in the main base, and having a first nut member mounted thereon;
a first screw rod mounted to rotate freely behind the main base, and screw-penetrating through the first nut member;
a first driven pulley mounted on the first screw rod;
a first drive pulley rotatably mounted on an extension base connected to the main base;
a first platform drive motor mounted on the extension base to rotate the first drive pulley; and
a first belt wound between the first drive pulley and the first driven pulley to transmit rotational force of the first drive pulley to the first driven pulley.

6. The collected sample pretreatment apparatus of claim 4, wherein the pump drive device comprises:
a second platform mounted to be raised or lowered along a second rail mounted at another front side of the main base;
a pump head mounted on the second platform to enable dispensing and coupled with the dispensing tip or the filter tip;
a dispensing pump mounted on the second platform and connected to the pump head to suck or dispense the buffer solution; and
a second platform drive device for raising or lowering the second platform.

7. The collected sample pretreatment apparatus of claim 6, wherein the second platform drive device comprises:
a second extension extending from the second platform to penetrate through a second through hole vertically formed in the main base, and having a second nut member mounted thereon;
a second screw rod mounted to rotate freely behind the main base, and screw-penetrating through the second nut member;
a second driven pulley mounted on the second screw rod;
a second drive pulley rotatably mounted on an extension base connected to the main base;
a second platform drive motor mounted on the extension base to rotate the second drive pulley; and
a second belt wound between the second drive pulley and the second driven pulley to transmit rotational force of the second drive pulley to the second driven pulley.

8. The collected sample pretreatment apparatus of claim 7, further comprising:
a position detection sensor mounted on a horizontal frame mounted on the main base, to detect a raised or lowered position of a detection target object provided on each of the first and second extensions, by using a light emitter and a light receiver; and
a controller for receiving a position signal from the position detection sensor to apply a control signal to the first or second platform drive device.

9. The collected sample pretreatment apparatus of claim 6, wherein the tip removal device comprises:
a tip removal block mounted to be raised or lowered along the first and second rails to press the spin tip or the dispensing tip;
a first through hole provided in a portion of the tip removal block and having an inner diameter which is greater than an outer diameter of the spin head to allow the spin head to pass downward and which is less than an outer diameter of the spin tip to remove the spin tip coupled with the spin head when the spin head passes upward; and
a second through hole provided in another portion of the tip removal block and having an inner diameter which is greater than an outer diameter of the pump head to allow the pump head to pass downward and which is less than an outer diameter of the dispensing tip to remove the dispensing tip coupled with the pump head when the pump head passes upward.

10. The collected sample pretreatment apparatus of claim 9, wherein the tip removal device further comprises an elastic support block mounted to be raised or lowered along the second rail, having the second platform mounted at a side to prevent falling of the tip removal block and adjust a height of the tip removal block in conjunction with the second platform, and elastically supporting the tip removal block by using a spring of a spring bar mounted on the tip removal block.

11. The collected sample pretreatment apparatus of claim 2, wherein, in the cartridge mounting device, a stopper is provided on the cartridge holder so as to be elastically coupled with a protrusion provided on the cartridge when the cartridge is inserted.

12. The collected sample pretreatment apparatus of claim 1, wherein the housing has a hinged door mounted at front to selectively open or close a cartridge inlet provided at front, a handle provided on top for carrying, an ultraviolet (UV) germicidal lamp mounted inside for disinfection after sample extraction, and command input buttons and display device mounted on a front surface.
